(19) United States
(12) Patent Application Publication
(10) Pub. No.: US 2003/0226962 A1
(43) Pub. Date: Dec. 11, 2003

(54) Method for generating neutrally charged stable compound particles beyond the energy range of the first family of matter

(76) Inventor: Arnold Lasky, Brooklyn, NY (US)

Correspondence Address: Ostrager Chong & Flaherty LLP, 30th Floor, 825 Third Avenue, New York, NY, 10022-7519, US

(21) Appl. No.: 10/279,618

(22) Filed: Oct. 24, 2002

Related U.S. Application Data
(60) Provisional application No. 60/335,759, filed on Oct. 24, 2001.

(51) Int. Cl. H05H 15/00

(52) U.S. Cl. 250/251

(57) ABSTRACT

The observation of a proportional relationship between the rest masses of all three families of matter led to a threefold extension of the periodic table of the elements, from the first family to the other two, and to the discovery of an energy well of fundamental particles (quarksaeptons) that is centered on the Z° boson, similar to that of binding energies centered on iron 56. This led to an explanation for hadron perpetuity, and to the discovery of the mechanism that governs the transformation of hadrons of lower mass (protons/neutrons) to those of higher mass (omega minus, et al). This, in turn, led to conclusions about the role of weak bosons in matter/antimatter transformations, and to the controversial proposition that entropy, a universal condition of the expanding universe, is transposed to its antithetical counterpart, antropy, in the contracting environments of a neutron stellar core or black hole.

### THE THEORY OF EQUIVALENT COUNTERPARTS

Every first family composite particle has a more massive counterpart, with equivalent properties, in each of the other families of matter.

### THE THEORY OF HADRON LIFETIMES

To achieve the maximum longevity of any hadron, the energy range of the ambient background must be maintained within the equivalent rest mass range of that hadron's family.

### THE THEORY OF BOSON CATALYSIS

An intermediate vector boson, as a particle, is incapable of mediating any transformation that permits the transformed particle to acquire a characteristic prohibited to intermediate vector bosons.

### THE THEORY OF FUNDAMENTAL PARTICLE SYNTHESIS

Fundamental particle formation (quark/lepton/weak boson) favors fusion below the rest mass of the Z° boson, and fission above the rest mass of the Z° boson.

### THE THEORY OF QUARK ANTROPY

Order in the universe is increased through the antropic absorption, by the most massive quark within a particular hadron, of a quantum of disordered gravitational energy equivalent to the difference between the ordered rest mass of that quark and the ordered rest mass of the least massive quark in the next most massive hadron.

### THE THEORY OF PROPORTIONAL MASS

The rest masses of the intermediate vector bosons, and the rest masses of all quarks and hadrons of the third family of matter, are divisible by, or are multiples of, the rest mass of the bottom quark; the rest masses of all leptons, plus the rest masses of all quarks of the first and second families of matter, are equal in sum to the rest mass of the bottom quark; each hadron of the first and second families of matter can be combined with one or more hadrons of the other family to equal the rest mass of the bottom quark.

### PARTICULAR FAMILY MATTERS

It is widely agreed, although by no means certain, that only three families of matter exist in the accepted theory of elementary particles and forces, the Standard Model. The Standard Model is a quantum field theory, with a distinct field being assigned to each particle and force, and where disturbances in these fields propagate energy and momentum. Elementary particles are disturbances in these fields consisting of discrete packets, or quanta, of energy. For example, the photon is the quantum particle of the electromagnetic field, and the proton is the quantum particle of the proton field.

The most recognized members of the first family are the baryons, consisting of the proton (charge +1), the neutron (charge 0), and the electron (charge −1). They are the constituent particles which comprise the atoms and molecules of ordinary matter. In addition to these is their less well known sibling, the electron neutrino. The electron and the electron neutrino constitute the leptons, one of only two kinds of fundamental particles of ordinary matter in the Standard Model. The other fundamental particle of ordinary matter is the quark, of which there are two in the first family, the up and the down. All of the above particles have counterparts in the second and third families, each with similar properties, but with progressively higher rest masses. Second and third family matter can be thought of as extraordinary matter.

For our purposes, the three varieties of neutrino from each family can be considered as a class which we shall call the neutronic leptons. The class consists of the first family electron neutrino (the electrino) and the electron antineutrino (the antielectrino or positrino); the second family muon neutrino, which we shall call the muino, and the muon antineutrino (the antimuino); finally, the third family tau neutrino, which we shall call the tauino, and the tau antineutrino (the antitauino). All neutronic leptons possess an electromagnetic charge of zero.

Combinations of quarks form the hadrons, which, in the first family, are the stable proton (one down and two up quarks) and the relatively stable neutron (one up and two down quarks). Other known hadrons are observationally unstable, and include the lambda (one up, one down, and one strange quark), and the omega- (three strange quarks). All quarks, regardless of family affiliation, have a fractional charge that is one third or two thirds of the electron, and possess an electromagnetic charge that is either positive or negative.

There is no first family analogue (three down quarks) of the second family omega-(three strange quarks), with a net charge of −1, because of the Coulomb force, which electromagnetically resists combinations of particles with the same electric charge. Apparently, the Coulomb force is not sufficiently strong at the energy level of the second family to prevent such a combination. It can be concluded that the Coulomb force is not a factor in the creation of hadrons with rest mass energies beyond the first family. Hadrons with three up quarks having +⅔ charge, or with three charm quarks, or with three top quarks, are prohibited because they would have an net electromagnetic charge of +2.

It was first proposed by Arnold R. Bodner, in 1971, that a new for-m of stable matter, that is composed of hadrons which incorporate strange quarks, might exist within stars. Roughly fifteen years later, Edward H. Farhi and Robert L. Jaffe coined the phrase “strangelets” to describe this postulated state of matter. Were this concept a true reflection of the real universe, the implications would be profound. Unfortunately, many theoretical and experimental physicists have since labored mightily to confirm the existence of strange matter, to no avail. For certain quantum mechanical reasons, it was assumed that this new form of matter consisted of combinations of up, down, and strange quarks within hadrons composed of more than three constituent quarks. In other words, there was thought to be no limit to the absolute size of a nucleus incorporating strange quarks, nor to the number of quarks incorporated within each such nucleus.

It was further assumed that, once formed in stars, strangelet material could have somehow migrated to Earth. They were prospecting for something called quark nuggets, but never found the mine. Perhaps they were just looking in the wrong place because strangelets are configured in a manner other than conjectured, and/or because strangelets are incapable of migration due to the circumstances of their birth.

The Author would like to explore the proposition that hadronic combinations of second, and/or third family quarks exist as stable nuclei that share similarities with the first family, including hadron size and quark number. Such hadrons would include combinations of one up and two strange quarks, let us call it the lambda “u”; one strange and two up quarks, let us call it the lambda “s”; one charm and two strange quarks, analogous to the neutron, let us call it the seutron; and one strange and two charm quarks, analogous to the proton, let us call it the chroton. For reasons that will become clear, charm quarks are not permitted to combine with up or down quarks in the cores of stars, but may do so in particle accelerators or during atmospheric collisions.

These known and postulated hadrons are composed, partly or entirely, of second family quarks, and are unstable at the rest masslenergy range of the first family of matter, about 1 GeV to 0 GeV. That is, they spontaneously decay into less massive particles while within the energy range of the first family. There should also exist third family counterparts of at least some of these same hadrons.

All of the above known and postulated matter particles have an antimatter twin, opposite in charge, but identical in all other properties. Combinations of quarks and antiquarks comprise the mesons, which are also unstable because matter and antimatter annihilate themselves. Our present day universe appears to consist of matter only, except for the brief existence of antimatter created, and then annihilated, in high energy collisions, which take place in particle accelerators or in the atmosphere.

Other than the protons and the leptons, which apparently never decay, all of the above particles have a limited lifetime, except for the neutronic leptons¹. However, we are restricted in the observation of these short-lived particles to conditions that exist, during particle collisions, at the energies and densities existing on the Earth. In isolation, even the neutron decays in less than fifteen minutes, unless it is combined with a proton, or is incorporated into a neutron star. Yet, a neutron decays into an electron, a proton, and an antielectrino, all eternal. ¹ has not yet been definitively proven that neutrinos possess mass

Eternal protons and electrons (and, under certain conditions, neutrons) have in common electric charges of the whole numbers +1, −1, or 0, whereas most other particles have fractional charges. The fact that all other hadrons and all mesons are not eternal, even though they too have whole charge numbers, can be distinguished. The shortness of the lifetime of a meson can be explained because it is composed of matter and antimatter, which quickly annihilate one another, whereas the brevity of the other hadrons may be just an artifact of earthly energies and densities. That is to say, at constant rest mass energies and densities which are too high for protons and neutrons to exist, the Author proposes that certain, if not all, other hadrons also enjoy perpetuity.

We have observed the decay of the neutron in the laboratory, and we can imagine the reversal of that process. It is undisputed that protons and electrons do not exist as independent particles in the core of a neutron star, without directly sampling its physical content or taking its spectrum, because that is predicted by quantum theory. Although the collapse of a neutron star has never been directly observed, nor its consequences certified by theory, the considered result of such a collapse is the direct emergence of a black hole. The absence of any known stellar structure that could retard such a result in a transneutron star is not proof of such absence.

Therefore, one may postulate stellar structures based upon the eternal lifetimes of particles composed partly, or entirely, of second and/or third family quarks, in extreme environments of constant high energy and density, provided that all physical laws are obeyed. Such environments must exist in collapsed bodies more massive than a neutron star, and should have existed in the era immediately following the Big Bang. Let us call that era, which continues to the present day, the Expansion.

We can extrapolate what the characteristics of these eternal particles would be in such extreme environments, comparing them to the well known characteristics of their first family counterparts, while still observing the accepted principles of physics. For instance, protons and electrons (and their antimatter twins) are routinely created in particle accelerators, out of pure energy, when discrete energy densities are briefly achieved. Such “artificial” particles exhibit the same properties as naturally occurring ones, eg: the ability to combine into ordinary atoms or anti-atoms, as the case may be. These man-made protons and electrons are also eternal, and, more importantly, they come into being out of whole cloth, as it were. That is, the manufactured proton is not assembled from individual quarks that were created first and then combined later. Individual quarks have never been directly observed in isolation.

### The Three Legged Table

Let us now explore some ramifications of being an “extended” (second and/or third) family member within the Standard Model. To be consistent, the properties of any specific kind of particle in one family, including its charge, spin, and spectrum, should correspond or relate to that of its respective counterparts in the other two families. Therefore, utilizing the generally recognized properties of first family protons and neutrons (composed of the up and the down quarks) as a model, we should be able to project similar properties to the respective hadrons of the other two families, factoring in the specific rest mass of each such other particle.

The up quark has a fractional charge of +⅔ with a rest mass of approximately 0.3 billion electric volts (GeV). The down quark has a fractional charge of −⅓ and is also approximately 0.3 GeV (it is slightly more massive than the up quark). Correspondingly, the quarks of the second family are the charm, with a fractional charge of +⅔ and a rest mass of 1.5 GeV, and the strange, charge −⅓ and 0.5 GeV, respectively. The third family's quarks are the top, charge +⅔ at approximately 175.5 GeV², and the bottom, charge −⅓ at 4.5 GeV, respectively. ² Pursuant to the Heisenberg Uncertainly Principle, the more massive a particle, the shorter its lifetime, and the more uncertain Its specific mass. The top quark is so massive, and its lifetime so short, that its specific rest mass can best be described as an average of many measurements centering on a value of around 175 GeV. For reasons that will be explained later, the Author has assigned 175.5 GeV as the rest mass value for the top quark because that is a multiple (39) of the rest mass value of the bottom quark, rounded oft at 4.5 GeV. Since the bottom quark is less massive than the top quark, it is more amenable to accurate calibration. The reader is advised that the bottom quark is the benchmark from which the rest mass values of hadrons, quarks and bosons will be computed and then rounded off, eg: the proton (1 GeV) plus the chroton (3.5 GeV) equals the bottom quark (4.5 GeV); or the strange quark at 0.5 GeV×9=4.5 GeV, or the Z° at 90 GeV=20×4.5 GeV.

No physical laws would necessarily be violated if, in an environment with a constant energy/density of 3.5 GeV, two charm quarks and one strange quark were to form a long-lived second family hadron, corresponding to the proton, which we shall call a chroton (Author's choice), or for two strange quarks and one charm quark to form a seutron (Author's choice), corresponding to the neutron, at a constant energy/density of 2.5 GeV. There should also exist a third family equivalent of the second family omega-, with three bottom quarks, let us call it the theta- (Author's choice).

At a constant energy/density of 355.5 GeV, the equivalent of a proton, the troton should exist (Author's choice), consisting of one bottom and two top quarks, and at 184.5 GeV, the equivalent of a neutron, the beutron (Author's choice), consisting of one top and two bottom quarks. The implications resulting from the conclusion that there are proton-like particles in the other two families are profound, when you consider what the effects would be if they were to interact, in a proton-like manner, with each other and with their neutron-like siblings, as we shall consider, in depth, later. The Author suggests that it is proper to consider a tripling of the periodic table of the elements.

### A Proof of Three Families by Simple Addition

Before his seminal work on the theory of the electron, Paul Dirac's first effort was an attempt to establish a fundamental connection between the microworld and the macroworld solely through the power of pure mathematical reasoning. Based upon a cosmological principle of his, the Large Number Hypothesis, he drew correlations between the very large numbers that represent the fundamental constants of nature in order to arrive at a new conclusion: that the gravitational constant “G” is inversely proportional to the age of the universe.

Controversial at the time, and still unproven, these ideas were never accepted by his peers. Nevertheless, Dirac continued to search for a theory of the microworld grounded on a “sound and beautiful” foundation. His theory aside, the quest still beckons.

Let us now examine the relationships between the rest mass values of the known hadrons in the Standard Model. Box “B” lists the rest masses of all of the known fundamental particles in the Standard Model, and of those known composite particles which are important for our purposes, as well as of certain postulated composite particles. It is important to note that the measured values of all of the known particles in the Standard Model are the averages of many measurements of each particle, in particle accelerator experiments, over extended periods. The greater the time that measurements have been taken of any particular particle usually means the time from when any specific particle was discovered, and this translates into more measurements and a greater accuracy of the measured value for that particle. Generally, the least massive particles have been the most accurately measured because they were discovered first and have been measured the most. Of equal importance, the more massive the particle, the shorter its lifetime, the more uncertain its mass, and the greater the number of potential particles, or channels, into which it can decay. For our purposes, please allow a variant of between ˜0.1GeV, at the low end of a mass gradient, and 0.2 GeV, at the high end, to account for this degree of uncertainty.

We are also constrained by the conservation of electrical charge, which allows for the creation of massive particles out of pure energy, provided that electrical charge, one of the constituent properties of all matter, be equally balanced by plus (+) and minus (−) values whenever particles or energy are transformed from one into the other. Generally speaking, neutronic or antineutronic leptons balance these transformations.

It appears to be more than mathematical coincidence that the the rest mass values of all of the known fundamental particles of the Standard Model (box B) total 355 GeV, which is equal to the rest mass of the troton (one bottom and two top quarks); that the rest mass of the troton (355.5 GeV) is equal to the sum of the rest masses of the beutron (184.5 GeV) plus the intermediate vector bosons (the Z° at 90 GeV and the composite³ W±at 81 GeV=171 GeV); that the rest mass of the beutron (184.5 GeV), with one top and two bottom quarks, equals the sum of the rest masses of the intermediate vector bosons (171 GeV) plus the theta- (13.5 GeV), with three bottom quarks; that the rest mass of the top quark (175.5 GeV) is equal to the sum of the rest masses of the bottom quark (4.5 GeV) plus the intermediate vector bosons (171 GeV); that the bottom quark (4.5 GeV) represents the sum of the rest masses of the chroton (3.5 GeV), with one strange and two charm quarks and the neutron (1GeV), with one up and two down quarks; that the rest mass of the chroton (3.5 GeV) equals the sum of the rest masses of the seutron (2.5 GeV), with one charm and two strange quarks plus the neutron (1GeV); that the seutron (2.5 GeV) equals the sum of the rest masses of the omega- (1.5 GeV), with three strange quarks plus the neutron (1 GeV); (see also the “transzeta gap”; the seutron decay channel of the chroton; and the beutron decay channel of the troton, infra). The Author believes that this pattern of mathematical relationships is too “sound and beautiful” not to have been constructed upon a foundation of fundamental truths⁴. ³ For our purposes, we shall consider the W+ weak boson and the W− weak boson to be one composite particle with a single mass of 81 GeV, and a potential, but unexpressed, electromagnetic charge of zero, until such time as the W± Interacts with a particle of matter, whereupon the charge becomes expressed as either plus one or minus one, depending upon the opposing charge of the interacting particle. The mass-to-charge association of the W± made a serendipitous appearance solely as a consequence of the proportional relationships between the masses set forth in this chapter. ⁴ Quoting Gary J. Feldman and Jack Steinberger in the Scientific American, February 1991, referring to the decay channels of the Z° boson prior to the time when the rest mass value of the top quark was known. “The electroweak theory predicts the contributions of the known channels to an accuracy of about 1 percent as follows for the combined quark channels, 1.74 billion eV . . . ”. This is in excellent agreement with a rest mass value for the top quark at 175.5 GeV (see the transzeta gap and note 5, intra).

[image]

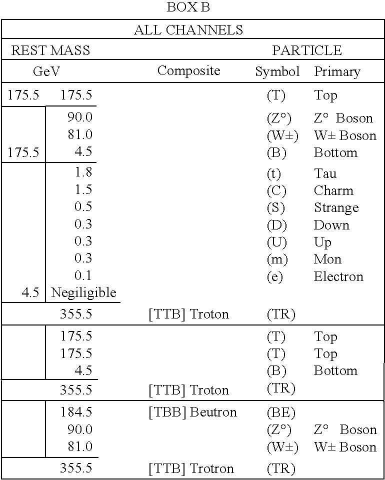

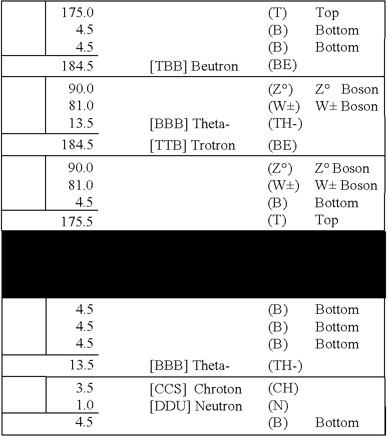

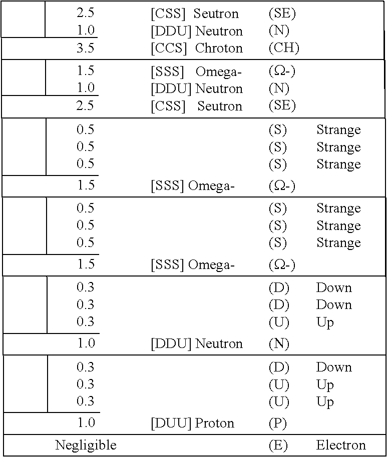

There appears to be a general law of proportional mass which decrees that all of the represented particles are divisible by, or are multiples of, or sum to the equal of, the rest mass of the bottom quark (4.5 GeV). Since all of the above mass values are rounded off averages of ongoing measurements, when a final value for the bottom quark is determined, all of the other values should be adjusted accordingly. Conversely, a determination of all the final values of those particles that are more massive, and less massive, than the bottom quark should be a confirmation of the value of the bottom quark. The relationships of the rest mass values of these particles to the bottom quark and each other, would constitute a proof, or disproof, of the theory.

### The Relation of Mass and Electric Charge to Family Number

The massive sphere of matter/bosons, as it appears in box “A”, is composed of concentric circles that each represent the rest mass/energy value of a corresponding hadron or intermediate vector boson. Only massive particles which have a whole number charge of +1, −1, or 0 are included, with rest mass values rounded off to the nearest 0.2 GeV. Neutrinos are not included because their mass, if proven, would be so negligible as to not materially affect the results. Envision another sphere of antimatter that has similar but opposite electromagnetic charges, except for the weak bosons, which retain their charges in both spheres because weak bosons have no antimatter equivalent.

At the center of the illustrated sphere is the most massive and stable third family hadronic particle, the troton (or antitroton), which is composed of one bottom and two top quarks, with a rest mass of 355.5 GeV, and an electromagnetic charge of +1. The next, in descending mass, is the beutron, composed of one top and two bottom quarks, at 184.5 GeV, and a charge of 0.

The next most massive particles are not composite hadrons, but are intermediate vector bosons in particle mode, and are the fundamental particle carriers of the weak force, also known as weak bosons. The Z° weak boson has a rest mass of 90 GeV and charge of 0, and the W+weak boson has a rest mass of 81 GeV and charge of either +1 or −1 (see note three).

The theta-, which is the analogue of the omega-, with three bottom quarks at 13.5 GeV and a charge of −1, brings us back to the hadrons, and terminates the third family of hadrons, with a total net charge of zero.

Enter the second family chroton, with one strange and two charm quarks, at 3.5 GeV and a charge of +1, followed by the suetron, with one charm and two strange quarks, at 2.5 GeV and a charge of 0. The omega-, with three strange quarks, at 1.5 GeV and −1 charge, terminates the second family of hadrons, with a total net charge of zero.

The first family neutron, at 1 GeV and 0 charge, is followed by the slightly less massive proton, at 1 GeV and +1 charge (and by the least massive baryon, the electron, a lepton, at 0.0005 GeV and −1 charge). They terminate the first family of hadrons (baryons) with a total net charge of zero.

You may ask, where are the second and third family leptons, the muon and the tauon? Although they cannot exist as particles at the extreme energy densities attendant to their respective family positions of rest mass within the sphere, their corresponding negative charges are conserved within the omega-(muon) and the theta-(tauon).

In the first family, there is no particle that is composed of three down quarks, with a −1 charge, which corresponds to the second family omega- or the third family theta-. Such a first family particle would be repelled by forces generated under Coulomb's law, which states that the force of repulsion or attraction between charges is proportional to the product of the charges and inversely proportional to the square of the distance between them. Yet the leptonic electron, having a −1 charge and being necessary to construct earthly atoms and molecules, can independently survive on the periphery of the sphere, because it has so little mass that it exists beyond the range of energies which would destroy it. It is also protected from destruction while safely cocooned within the confines of the neutron.

Contrast the relatively massive muon and tauon leptons, which cannot support the creation of atomic/molecular structures because they cannot survive as stable massive particles at the energy densities of the second and third families. Yet they conserve their electric charges, like the grin of the Cheshire cat, in the omega- and the theta- particles, which do have the ability to participate in the creation of the analogue of neutral atoms, as we shall see.

### The Relation Between Hadron Mass and Star Structure

Each particle of the first family, our earthly world of matter, was created at a specific density and quantum of mass, and exists at a discrete level of rest mass, within a specific range of energies, from almost 1 GeV to 0 eV. Regardless of the specific rest mass/density at which it was created, each first family particle can survive at energies extending to “absolute” zero, and at the ambient density of a “perfect” vacuum. From there, the electron and the proton independently exist up to the mass/density where they merge to form the neutron. The neutron decays in isolation or when its structure is overcome at the mass/densities found in the center of a star more massive than a neutron star. Only particles which permanently exist wholly within the parameters of this discrete mass/energy/density range belong solely to the first family.

Other than protons and neutrons, all known hadrons are observationally unstable. They do not exist entirely within the energy range of the first family, and are really hybrid combinations of first and second family quarks, ie., they all appear at specific energies above the range of the first family. Let us call them hybridons (Author's choice). Although their existence is fleeting at first family energies, the Author proposes that hybridons experience perpetual lifetimes so long as their environments are constantly maintained within their own discrete energy parameters. Those parameters extend from the rest/mass energy level at their birth to that of the rest mass/energy of the next more massive hadron.

A remnant star is a non-gaseous star which resists collapse because it is composed entirely of closely packed Fermionic particles that have collapsed to a degenerate state. Fermion degeneracy, which is a fundamental law of nature, was first espoused as an exclusion principle by Wolfgang Pauli. It provides that two identical Fermions, which are in exactly the same quantum state, are excluded from occupying the exact same space.

The electron is a Fermion. A white dwarf is a solid remnant star composed of a closely packed electron core and an iron nuclei mantle. It has an upper mass limit of 1.4 solar masses. This is the Chandrasekhar limit, which holds that a star of more than 1.4 solar masses will collapse when its fuel is exhausted. White dwarf stars resist further collapse due to the stable structure provided by electron particle degeneracy.

An exception to the 1.4 solar mass Chandrasekhar limit is a star that has overcome electron degeneracy and collapses to the density of the neutron. It has an upper mass limit of approximately 3 solar masses. This is the Oppenheimer-Volkoff limit. It states that a neutron star of greater than about 3 solar masses will collapse indefinitely to a black hole. Neutron stars resist further collapse due to the stable structure provided by neutron particle degeneracy.

The Author proposes that there are exceptions to the Oppenheimer-Volkoff limit. These are remnant stars that have overcome neutron degeneracy and replaced it with stable structures based upon transneutronic particle degeneracy. These stellar remnants consist entirely, or partly, of second and/or third family hadrons, which all exceed the rest mass/density of the most massive first family particle, the neutron, and which all achieve perpetuity within their respective constant energy ranges.

A solar remnant more massive than a neutron star can thereby attain the required structure to resist further collapse to a black hole, provided only that the propagation of sound in its core does not exceed the speed of light. The speed of sound would exceed the speed of light (prohibited) at the epicenter of a solid chroton stellar core, at approximately 3.5 solar masses. However, the speed of sound does not exceed the speed of light in a liquid chroton core.

Let us assume that, when a neutron star has exceeded its upper mass limit, its nuclei collapse to the discrete energy/density range of the next more massive degenerate nucleon, the lambda (one up, one down, and one strange quark). What occurs is that one of the down quarks (0.3 GeV) within its core, having −⅓ electric charge, is gravitationally compressed to a specific density, whereupon it absorbs a quantum of gravitational energy (0.2 GeV), which converts it into a 0.5 GeV strange quark that has an electric charge of −⅓. That strange quark then combines with the two abutting quarks to form a lambda, which is the raw material of a lambda star.

A slightly more massive remnant body, within the discrete energy/density range of the degenerate lambda “u” (one up and two strange quarks), transforms the other down quark into a strange quark to form a lambda “u” star (Author's choice), and a muino carries off the positive charge. In a star which is slightly more massive than a lambda u star, the remaining up quark is transformed into a strange quark, and a muino carries off the positive charge. The three strange quarks then combine to form the hadronic structure of a degenerate omega- star, since the Coulomb force is apparently not a factor in the creation of hadrons with rest mass energies beyond the first family.

One of the strange quarks of an omega- ion, within the core of a slightly more massive star, is compressed to a specific density, whereupon it absorbs a quantum of energy (1 GeV) that converts it into a 1.5 GeV charm quark with +1/3 electric charge. An antimuino carries off the negative charge. The mass of the charm quark is the same as that of the omega-, less the binding energy. That charm quark combines with the two abutting strange quarks to form a seutron. Moving along the mass/density gradient, a newly created charm quark combines with the abutting charm and strange quarks in the seutron to form a chroton, which terminates the class of transneutronic second family degenerate stars.

By the time that the omega- evolves, all of the first family quarks in the arena of transformation, at the epicenter of a stellar core, have already been transformed into strange quarks. Therefore, at the time that the charm quark appears, there are no remaining up or down quarks in the epicenter, and the only feedstock for further nucleogenesis are strange quarks.

First family/charm quark hybridons are forbidden in remnant stars, but not elsewhere. Since there is insufficient time for quarks to evolve in a particle accelerator, or in high energy atmospheric particle collisions, they could be created there, provided only that the required collisional energies are present. However, hybridons of particle accelerator or cosmic ray origin would have very short lifetimes because of the ambient first family energy background.

Although combinations of charm and strange quarks result in liquid stellar cores, remnant stars composed of hybridons that incorporate third family quarks would be so dense that the speed of sound in a liquid would exceed the speed of light, which is prohibited. However, this prohibition does not pertain to third family gas stars.

Therefore, one can visualize stable combinations of second and third family quarks within gas stars. In such stars, the eta (Author's choice) would be the analogue of the lambda and would comprise a charm, a strange, and a bottom quark. Gas stars composed of only third family hadrons are also permitted.

This brings us to the reason of why the parameters of the mass ranges of the three families of matter are what they are. The Author proposes that there is a relationship between the rest mass value of the most massive hadron that is composed exclusively of the quarks of a particular family, and the propagation of the speed of sound at the core of the most massive star composed only of those quarks. For example, if first family quarks were any more massive, the speed of sound at the core of a (solid) neutron star would exceed the speed of light, which is prohibited. Similarly, if second family quarks were any more massive, a remnant star composed of second family quarks only could not exist, because the speed of sound at its (liquid) core would exceed the speed of light. For the same reason, the allowable rest masses of third family quarks are constrained by the speed of sound at the (gas) core of the most massive possible third family troton star. A troton star is not a remnant star.

In a sufficiently massive gas star, one of the two charm quarks within the chroton is transformed into a 4.5 GeV bottom quark with −⅓ charge. That newly converted bottom quark combines with the abutting charm and strange quarks to form an eta hybridon.

The next more massive hadron is the epsilon hybridon, incorporating another bottom quark that is transformed from a charm quark, which then combines with the abutting bottom and strange quarks. The last bottom quark is transformed from the remaining strange quark, and instantly combines with the two abutting bottom quarks to form a 13.5 GeV theta-particle with −1 electric charge.

Continuing the above pattern of nucleogenesis, the theta-, which has a rest mass of 13.5 GeV and a +⅓ electric charge, would form the top quark from one of the bottom quarks, as the second family charm quark had metamorphosed from one of the second family strange quarks in the omega-. However, any fundamental particle more massive than the 4.5 GeV bottom quark must “jump” the 171 GeV “transzeta gap” (Author's choice).

The transzeta gap is an energy span of 171 GeV (box B), equaling the sum of the 85.5 GeV mass differential between the Z° boson and the bottom quark (90 GeV-4.5 GeV=85.5 GeV) on the one hand, and the mass differential between the top quark and the Z° boson (175.5 GeV−90 GeV=85.5 GeV) on the other hand⁵ (see box B). It appears that the Z° boson is at the stable bottom of a mass/energy well for all massive fundamental (quark/lepton/weak boson) particles. Analogous to the relationship between iron 56 and the first family table of the elements, fundamental particle formation apparently favors fusion below 90 GeV, and fission above 90 GeV. ⁵ The transzeta gap made a serendipitous appearance solely as a consequence of the proportional relationships between the hadronic masses set torth above in A PROOF OF THREE EFAMILIES BY SIMPLE ADDITION.

Therefore, the next permitted mass value for the top quark must be 175.5 GeV. As it would require the fusion, below 90 Gev, of so many lighter particles to form the supermassive top quark, it is not likely that they could all physically come together to participate in such transformation, at exactly the same time and place. Consequently, the formation of trotons and beutrons must take place via fission only, and only above 90 GeV.

### The Cosmic Forge

In the above description of nucleogenesis, there appears to be a correlation between rest mass transformation and electromagnetic charge reversal involving each member quark of each respective family of matter. In repeated quantum “jumps” that are related to the difference in the increased mass of each successive progenitor star, the most massive quark within the core of the transforming star is gravitationally compressed to a specific mass/density, corresponding to the least massive quark in the next more massive hadron to be transformed. Thereupon, the transforming quark absorbs a quantum of gravitational energy equivalent to the difference in the rest mass between itself and the quark to be transformed. The absorbed energy converts the less massive quark into a more massive quark within a more massive hadron.

Gravitational energy has been converted into mass, and neutronic/antineutronic leptons conserve electric charge. And so it goes, in step-like jumps, as the degeneracy pressure of yet more massive Fermionic hadrons, each created within a correspondingly more massive star, continues to resist the increased gravity attendant to that respective star. Because gravity is attractive, the hadrons are driven toward the center. The more massive the remnant, the more strongly that disordered gravitational energy augments the ordered rest/mass energy of the quarks within its hadrons by compressing them into ever higher masses, and ever denser energy states.

Quarks resist compression until the ambient pressure at the epicenter exceeds the point where the resistance of the most massive quark within a particular hadron is overcome. That point corresponds to the quantum energy level of the least massive quark within the next most massive hadron, because that represents the minimum mass/energy differential between the two hadrons. Since individual quarks cannot be squeezed apart, they are obliged to remain in place, and this provides the mechanism that “fixes” the transfer of general kinetic gravitational energy into the specific potential energy state of mass. Thus, the hammer of gravity forges hadrons of higher mass within the vise of quark cohesion.

### The Author Has No Quarrel With Sir Arthur

Let us call this forging process an example of ANTROPY (Author's choice), defined as the increase of order in the universe. But wait! What about the second law of thermodynamics? To quote Arthur Eddington in his book, The Nature of the Physical World, “The second law of thermodynamics holds, I think, the supreme position among the laws of Nature . . . if your theory is found to be against the second law of thermodynamics I can give you no hope; there is nothing for it but to collapse in deepest humiliation.” The Author has no quarrel with Sir Arthur . . . in an expanding universe. However, one must simultaneously visualize the universe as a whole, and at the Planck length, to appreciate the movement of energy in a contracting universe. A black hole can be considered an environment that simulates a contracting universe, within the expanding universe, because nothing can escape its event horizon, and the attraction of gravity pervades all. In a sense, even the core of a neutron star can be considered such an environment, regarding massive particles within, which can never escape. Depending upon their masses, the merger of two neutron stars produces either a black hole or just a larger neutron star.

The basic question is: Why does everything disperse in the observable universe? The answer is that every Planck length point in space is expanding away from every other such point at the same time. Therefore, any observable thing that takes up space, that is, everything less dense than a black hole, including energy and space itself, is simply acting to fill the available volume that is constantly increasing from every point in space-time as the observable universe expands.

It is well recognized that a black hole is a region of space-time wherein the laws of physics are poorly understood, given that no observable information can escape its clutches. Even time stands still at its event horizon, from the viewpoint of an observer outside that black hole. Looking at it in a special way, the observable universe can be thought of as an expanding black hole, from the viewpoint of an observer within the “universal black hole”.

Controversies, related to thermodynamics, currently rage between proponents of the theories of Roger Penrose and Stephen Hawking as to whether a singularity inhabits the center of a black hole, and whether a black hole can radiate energy. Therefore, no sacred cows should exist regarding the thermodynamics of a black hole, including the second law, according to the Author, who is a lawyer⁶. ⁶ True, but a joke, just a play on words.

It would be helpful to regard each black hole, of whatever size, as the seed of a new expansion within space-time. It is a place both of ending and of beginning, where expansion ends and contraction begins, with the potential of expanding again in the “infinite” future. It is a place where mass, energy, and even the vacuum energy of space itself contract upon themselves, accumulating substance from without, until a critical point is reached when the reexpansion of space-time from within is the only option to preserve a fundamental truth—that there is no absolute state of rest. In other words, in the absence of the movement of the Expansion, movement of some kind must be maintained everywhere, at all times, if only at the Planck length. Because of that fundamental truth, time uniformly marches forward within and without the event horizon, given that a black hole still retains angular momentum. Time only appears to be suspended within the black hole from the viewpoint of an observer outside of the black hole.

Space-time expands and contracts, transforming energy and mass into one another. Within the event horizon of a black hole, each point in space is gravitationally driven toward one another. In this attractive environment, things tend to increase in order, entropy decreases, and antropy increases. The demarcation line between entropy and antropy is the point where and when second family matter first makes its appearance. That happens at the epicenter of a remnant neutron star, when one of the down quarks of a neutron absorbs a quantum of gravitational energy which converts it into a strange quark and transforms the neutron into a lambda. Whit results is a lambda interior/neutron exterior remnant star. Although energy may escape the perimeter of the lambda star thereafter, none may escape the antropy barrier at the core/mantle interface.

### Ironic Exchanges Precede Degenerate Relations

The lightest first family gas star that has experienced at least some hydrogen burning ultimately contracts to what is known as a white dwarf. When such a gas star, of between 0.08 and 0.3 solar masses, has depleted, but not exhausted, the nuclear fuel at its epicenter, it will begin to contract only there, even as the rest of its core and inner shells continue to burn, because fusion energy no longer exerts sufficient pressure to resist gravity. Reduction of fusion energy cools the core which shrinks the star. In a sufficiently massive star, contraction heats and compresses the central core, which is composed of the lightest fusion ash, helium. The heavy nuclei detritus, up to and beyond iron, that had been captured from earlier supernovae, and incorporated within the core, is heated, expands, becomes buoyant, and is convected to the outer layers. There each such nucleus sheds its absorbed energy, cools, and settles back toward the center. The process is then repeated, cooling the star.

In the core of a gas star of between 0.3 and 0.9 solar masses, helium fuses to carbon. At the solidifying epicenter, the iron nuclei at the center, and the other heavy elements, progressively cool from a gas to a liquid, and ultimately, to a solid. With depth, they are also progressevely stripped of their electrons. Electrons are Fermions. The epicenter gradually contracts, even as the outer core and outer shells continue to burn, but avoids collapse because of electron degeneracy pressure from Fermionic electrons that have been squeezed to a point where they are so close that further compression is prohibited. If this were otherwise, their equivalent electronic wave functions would overlap and place them all in the same prohibited quantum state. With the fusion of the last of the hydrogen/helium, the star ultimately shrinks to a totally solid state, with a degenerate electron plasma core, surrounded by an ionic iron mantle, beneath a crust of pre-iron elements that is stratified by density.

### Stellar Transformations

A star of between 0.9 and 1.4 solar masses will continue igniting elements in its core that are progressively more dense than helium. The successive ash products of these “heavier” elements are progressively more massive and more dense than each preceding element. Depending upon the mass of the star, the composition at the epicenter of the core graduates from the lightest fusion ash, helium, through carbon, oxygen, and silicon, up to iron. Because iron is the most energetically stable element in the periodic table of the elements, iron nuclei cannot fuse to convert mass into energy.

When nuclear burning ceases at the solidifying epicenter of a star of between 1.4 and 3.0 solar masses, gravitational contraction overcomes electron degeneracy pressure, and freely roaming plasmic electrons are “squeezed” into individual protons, creating neutrons. Actually, a neutron is created when an up quark within a proton absorbs energy from a decaying electron, converts that energy into mass, and is transformed into a down quark.

Free neutrons are not eternal. They achieve immortality in a neutron star because the neutron is a Fermion. Degenerative pressure exerted by Fermionic neutrons arrests further collapse. As neutrons begin to accumulate in the core, the star slowly shrinks and cools to a solid degenerate neutron epicenter with an iron mantle, beneath a crust of pre-iron elements that is stratified by density.

There is no implosion shock wave and rebounding supernova. Neither do the core neutrons, nor the proton/neutron molecules of the iron mantle, dissociate under the extreme pressure, as that would create a dense accumulation of free protons, which would reconstitute the original hydrogen nuclear fuel. The reconstituted fuel would first appear at the epicenter, where it would then regenerate fusion, leading to the synthesis of higher elements to iron, and then a collapse to neutrons, thereby creating an endless cycle tantamount to perpetual motion, which is forbidden.

Rather, the antropic forging of heavier degenerate hadrons continues in stars more massive than those that contract to a neutron star. The end result is dependent upon the gross rest mass of the initial gas star, after it has completed mass shedding through its solar wind, and after the nuclear fuel at the epicenter has been so exhausted that nuclear fusion no longer provides sufficient energy to resist the gradual contraction of the core. No neutron star (or transneuron star) has ever been observed that exceeds 2.0 solar masses.

If the mass of a star is 3.0 to 3.5 solar masses as it starts its collapse, the neutron core continues to gradually contract, through a series of increasingly more dense and degenerative hybridonic/chrotonic epicenters, each reflective of the increased rest mass of the next more massive hadron. Each subsequently formed epicenter is surrounded by a comparatively less dense solid shell that had been the matrix of a comparatively more massive prior core. The degenerative neutrons within the solid core, and the degenerative hadrons of each later core, in turn, resist collapse, and provide the nucleonic feedstock for the cores and the inner shells; to follow.

Regardless of the mass of any particular family quark, the strength of its fractional electromagnetic charge always remains exactly the same as those of the quarks of all other families, differing masses notwithstanding. Similarly, the force acting between quarks not only binds them together within a hadron, but also regulates the same approximate distance between them, regardless of mass, because quarks resist merger or separation exponentially as their masses increase linearly. In other words, the more massive the quark, the much greater is its resistance to separation. Therefore, the shrinkage in distance between quarks, with increasing mass, is negligible. For our purposes, quark separation, regardless of family affiliation, is a constant.

Although quarks of all families are point-like particles, they are not without some dimension (volume), as lower mass quarks do have a longer wave function and so are quantumly larger, and less dense, than more massive quarks. In other words, the more massive the quark, the shorter its wave function, the denser it is, and the smaller it is. Nevertheless, the size difference between quarks, although not zero point, is still negligible. For our purposes, quark size is a constant.

The hadron is a composite particle, containing three quarks of fractional charge. A composite hadronic particle, such as a proton or a lambda, consists of a single nucleon of whole unit charge. The density of a hadron increases almost linearly because its point-like quarks gain mass in specific quanta, while the virtual “volumes” of the quarks remain essentially the same. The point-like size of quarks, and the relatively invariable distance of separation between them, prevent hadrons from getting too large or too small. Therefore, the size of all hadrons, no matter their mass or density, is approximately the same as, or only marginally less than, that of the proton. Like the bed for Goldilocks, the size of a hadron is always “just right”, whatever its composition. For our purposes, the size of hadrons is a constant. Therefore, the corpus of a remnant star will be approximately the same size, marginally decreasing with mass, whatever the composition of its hadrons.

### A Strange and Charmed Ballet

As gravity overcomes the resistance of the neutrons in a neutron star (one up and two down quarks), further collapse is averted by nucleogenesis, ie: the progressive transformation, quark by individual quark, of the first family quarks within each neutron, into the next generation of quarks having greater mass. Each successive quark absorbs a quantum of gravitational energy equivalent to the mass differential between the transforming quark and that of the quark to be transformed. Neutronic leptons balance the transformations.

The least massive hadron beyond the neutron involves the transformation of one down quark (0.3 GeV) in each neutron into a strange quark (0.5 GeV), by the absorption of 0.2 GeV of gravitational energy. This transforms the neutron into a lambda hybridon (one up, one down, and one strange quark), because that requires the least possible quantum increase of mass to the next most massive quark. The result is a lambda core/neutron mantle with a solid iron crust.

The next least massive quantum increase involves the creation of a lambda “s” hybridon (one up, and two strange quarks), by the transformation of another down quark into a strange quark, which precipitates the “migration” of the lambda epicenter into the shell which surrounds the now lambda “s” epicenter. This is not to suggest that individual physical hadrons actually move through the surrounding solid material. Rather, as each inner lambda is replaced by being transformed into a lambda “s”, an outer neutron, in turn, is replaced by being transformed into a lambda, and so on.

The epicenter of the progressively stratifying solid core gradually transmutes into omega- particles, the least massive second family hadron composed entirely of second family quarks only. In remnant stars, the omega- is the only available feedstock for the production of seutrons, because the exhaustion of all less massive hadrons in the manufacture of the omega-, at the epicenter, leads to the absence of any other feedstock for successive transformations.

The seutron (2.5 GeV) is the second family equivalent of the neutron, with one charm and two strange quarks. It is created when one strange quark (0.5 GeV), within an omega-, absorbs the mass equivalent of 1 GeV, and metamorphoses into a charm quark (1.5 GeV). As the seutron replaces the omega- at the epicenter of the stratifying core, the omega- contemporaneously migrates to form the next abutting hadron shell.

The next epicenter hadron is the chroton (3.5 GeV), the second family equivalent of the proton, with one strange and two charm quarks, ie: the equivalent of hydrogen (Hc, chrohydrogen). It is created when the remaining strange quark, within a seutron, absorbs the mass equivalent of 1 GeV, and metamorphoses into a charm quark. In remnant stars, the seutron is the only available feedstock for the production of chrotons.

A positively charged ionic chroton (3.5 GeV) will combine with a negative omega-ion (1.5 GeV) to create a neutral second family atom of chrohydrogen (5 GeV). This is analogous to the atomic electron shell around a proton, but here the balancing negative charge resides within the nucleus. Chrotons and seutrons combine to create the second family equivalent of isotopic deuterium and tritium ions, ie: chrodeuterium (6 GeV), and chrotritium (8.5 GeV). The addition of an omega- particle (1.5 GeV) transforms them into atomic isotopes (7.5 GeV and 10 GeV, respectively).

The combining of a seutron (one charm and two strange quarks) and/or an omega-ion (three strange quarks) with a chroton ion (one strange and two charm quarks) increases the mass, but decreases the density, of each resulting compound hadron, relative to the chroton. This is because the rest mass of a strange quark is one third that of a charm quark, while the dimension (“volume”) of a point-like charm quark is virtually the same as that of a point-like strange quark. Density is defined as mass divided by volume. Dividing their masses by essentially zero volume, a charm quark is virtually three times as dense as a strange quark.

The density of a hydrogen atom (with an electron) is diluted relative to a hydrogen nucleus (without an electron), because the mass of the monolithic electron is negligible relative to the very massive proton/neutron nucleus, and because the volume of the composite nucleus is negligible relative to the electron orbital volume. Because up and down quarks have about the same mass, the proton is almost as massive as the neutron, and additional neutrons hardly affect the quark mass ratios of isotopic deuterium and tritium.

Now compare the quark mass/density ratios of atomic chrohydrogen (one chroton and one omega-), and/or isotopic chrodeuterium (one chroton and one seutron), and/or isotopic chrotritium (one chroton and two seutrons), relative to ionic chrohydrogen (one chroton only). Atomic chrohydrogen and its isotopes are diluted relative to ionic chrohydrogen, because the quark mass ratio of the seutron, with just one heavy charm quark, or of the omega-, with no charm quarks at all, is less than that of a chroton ion, with two charm quarks, while quark volume remains virtually the same. Contrast this with the hydrogen atom and its isotopes, where an increase in mass is closely followed by an increase in density, because the up and the down quarks that make up the proton and the neutron are nearly equal in mass and “volume”.

Ionic chrohydrogen (3.5 GeV) is the densest chrotonic hadron, at a quark mass density ratio of 6: 1, with two charm quarks (1.5 GeV each) that total 3.0 GeV, relative to one strange quark at 0.5 GeV. In order of decreasing quark mass density, ionic chrodeuterium has a quark mass density ratio of 3:1, followed by ionic chrotritium at a ratio of 2.4:1. The seutron has a quark mass density ratio of 1.5:1. All chrotonic atoms share exactly the same quark mass density ratio of 1.5:1 with the seutron, regardless of the total mass of any particular atom or the number and types of its constituent quarks.

At the epicenter, positively charged chroton ions (chrohydrogen), which are the least massive but most dense chrotonic particles, begin to appear, nucleon by nucleon. The epicenter gradually fills with ionic chrotons newly minted from the seutron core matrix, which is now converted into a new seutron shell that replaces the prior omega- shell. The omega-shell then replaces the preceding hybridon shells, and so on. Meanwhile, the remnant of a slightly more massive collapsing star (still less than 3.5 solar masses) continues to manufacture new seutron and omega- particles even as the ionic chroton core is growing.

Like hydrogen, chrohydrogen is a nuclear fuel. Also like hydrogen, chrohydrogen should liquefy under extreme pressure. Chrotons and seutrons should liquefy at the density and pressure where seutrons transform to chrotons. The speed of sound would not exceed the speed of light in a liquid chroton core below a threshold of 7 solar masses. Ionic chrohydrogen should not fuse to chrohelium at the density and pressure where seutrons transform to chrotons.

To create a chroton, tremendous pressure is required to transform a strange quark into a charm quark within the seutron. At the instant of their birth within the epicenter of a remnant star, the first chrotons should be surrounded by progenitor seutrons. The ambient pressure and temperature surrounding chrotons at their creation should be more than sufficient to drive abutting seutrons to fuse with the newborn chrotons.

Not all chrotons acquire seutrons, however, as many should come into being having contact solely with other chrotons, and others with only one seutron. As a proton may acquire a maximum of two neutrons (tritium), so a chroton should be limited to the acquisition of only two seutrons (chrotritium). At the liquid chroton/seutron interface, chrotons should interact with seutrons, producing liquid ionic chrodeuterium (one seutron) and liquid ionic chrotritium (two seutrons).

The density (6:1) of liquid chrohydrogen ions should remove them from the seutron reaction zone, to settle at the epicenter. Chrotons that have contact with only one seutron should form ionic chrodeuterium (3:1), to accumulate in a liquid stratum abutting the epicenter. Others, having been transformed to ionic chrotritium (2.4:1) by the absorption of two seutrons, should be “closed” to the absorption of any more seutrons, and they would form an inert liquid layer between the liquid chrohydrogen core/chrodeuterium mantle and the solid seutron layer above.

First family tritium (PNN) is unstable because it transforms to helium 3 (PPN) when one relatively massive neutron spontaneously decays into a less massive proton and a still less massive electron. Contrast second family chrotritium (CHSESE) which should be stable because the more massive chroton is not a permitted decay channel of the less massive seutron. The intervening closed chrotritium liquid ion layer should prevent further interaction between the inner liquid chrodeuterium ion shell and the outer solid seutron layer.

In a slightly more massive star (less than 3.5 GeV), additional seutrons should transform into chrotons, and the new chrotons should bind with still other seutrons, rapidly depleting the solid seutron shell faster than it can be replenished by the solid omega- layer. In time, the seutron shell would be reduced to a thin region where omega- particles are transforming into new seutrons. This should permit the closed (to additional seutrons), but positively charged, liquid chrotritium layer to make contact with negatively charged omega-particles in the thin seutron/omega- transformation zone. Positive chrotritium ions are attracted to the negative omega- ions, which should then merge to produce chrotritium atoms. Atomic chrotritium production would then compete with seutron/chroton production for the available omega- particles. Eventually, chroton production should terminate.

Thermal convection should bring chrotritium ions to the omega- interface, there to transform to chrotritium atoms. Since atomic chrotritium has the same density as the seutrons it is replacing, once the ionic chrotritium shell is entirely converted to atomic chrotritium, newly formed liquid seutrons would then be free to circulate, by thermal convection, through the inert layer of like density liquid chrotritium atoms, to the liquid ionic chrodeuterium layer, there to coalesce into liquid ionic chrotritium, which would then circulate to the omega- layer, there to take atomic form. Atomic chrotritium production should gradually deplete the ionic chrodeuterium shell and the omega- layer.

Eventually, the omega- layer would be reduced to a narrow region where the lambda “s” is transforming into omega- ions. By this time, chrotritium production should have completely exhausted the reservoir of available seutrons, to end seutron production. The absence of new seutrons would prevent further chrotritium production. Thermal convection currents should then bring liquid ionic chrodeuterium into contact with the newly forming omega- ions to produce atomic chrodeuterium.

The rotation of the remnant chroton star conserves the angular momentum of its progenitor gas star, which sets up a spinning within the liquid chrotonic core, to create a dynamo effect that would be amplified by all of the above described convective electromagnetic interchanges. The resulting magnetic field should then be many orders of magnitude greater than any other stellar object.

Such an object is called a magnetar, which was first postulated as a neutron star by Robert Duncan and Christopher Thompson, in a 1992 paper in the Astrophysical Journal. In the May, 1998 issue of Nature, Chryssa Kouveliotou reported the measurement of the magnetic field of SGR 1806-20 at eight hundred trillion gauss, at least one hundred times stronger than any known star. The intense magnetic field of a magnetar should be of limited duration, lasting only until atomic chroton production terminates. Thereafter, only the rotation of the liquid core would support the magnetic field, reducing its strength one thousandfold, to that of a radio pulsar.

In gradations of solar mass density, atomic fuels should fuse at 3.5 solar masses, ionic chrodeuterium at 5.25 solar masses, and ionic chrohydrogen at 7 solar masses. While dense ionic fuels occupy the inner core, neutrally charged atomic fuels fill the outer core. Being electromagnetically neutral, less dense atomic fuel ignites first, but more extreme conditions of temperature and density would be required to ignite denser chrotonic ions because of their electromagnetic repulsion.

Although the masses of atomic chroton fuels differ significantly from each other, they all occupy the same exact position on the quark density gradient. Being equally dense, they should intermix rather than stratify, with the result that all neutral atomic fuels should ignite at the same time, provided that they are equally compressed (at the same depth).

The ash product of all sources of chrotonic fusion is the second family equivalent of helium, ie: Hec, chrohelium (2×3.5 GeV =7 GeV). Although the total rest mass of the new compound hadron is 7 GeV, nevertheless the primary hadron unit of chrohelium is still the 3.5 GeV chroton. Chrotonic seutrons and omega- particles should be liberated in chain reactions, during atomic chrohydrogen fusion, to be immediately captured by the chrohydrogen ash, ionic chrohelium, resulting in the production of atomic and isotopic chrohelium. Atomic and isotopic chrohelium are more massive, but less dense, than ionic chrohelium or ionic chrohydrogen, because of the incorporation of relatively less massive seutrons and omega- ions into the nucleus. Being a compound hadron, ionic chrohelium is about twice as massive as ionic chrohydrogen, but because of the loss of the binding energy, it is slightly more dense than ionic chrohydrogen, which is a primary hadron. The speed of sound at the epicenter of a liquid ionic chrohelium core should not exceed the speed of light below a threshold of 7 solar masses.

Any gas star with a core of between 3.5 and 7 solar masses at the beginning of its collapse should continue nuclear burning in its outer shells, and gradually contract, supported in the core by degenerate matter, and in the outer shells by fusion, until the ignition point of the atomic chroton fuel is exceeded. That ignition point should occur at the ionic/atomic interface, at a depth corresponding to 3.5 solar masses. Atomic chrotons should fuse at a lower density and temperature than ionic chrotons.

As ionic chrohydrogen (6:1) is twice as dense as ionic chrodeuterium (3:1), which itself is twice as dense as atomic chrohydrogen (1.5:1), a discrete density discontinuity should form between each layer that extends out from the ionic chrohydrogen epicenter. The middle layer, composed of ionic chrodeuterium, and the last layer, composed of atomic/isotopic chrohydrogen, inversely halves the mass/density of the layer before it.

Ignition should fuse the highly compressed atomic fuel at the ionic/atomic interface, to heat and compress and ignite the chrotonic atoms above. There is no implosion, because the ionic epicenter would not have been sufficiently heated and compressed to overcome the positive charge repulsion and the degeneracy of the chrohydrogen/chrodeuterium. Because it has no time to settle to the liquid inner core, the relatively dense energized chrohelium detritus of fusion would be propelled off the core, in a shock wave, through the mixture of chrotonic fuels, which is ignited as the wave front propagates. The shock wave would gather strength from ongoing fusion as it expands, until it bursts through the insulating overburden, most of which it expels, along with most of the unburned fuel, the remaining pre-fuel feedstock, and the energy converted from mass. It is called a supernova.

Because mass within the spherical chrotonic core should be distributed in three distinct layers, a collapsing gas star of between 3.5 and 5.25 solar masses would only ignite the mixed atomic fuel outer shell, leaving a chrohydrogen/chrodeuterium ion remnant core of between 1.75 and 2.6 solar masses, and should expel between 1.75 and 2.6 solar masses, including most of the overburden. A collapsing star of between 5.25 and 7 solar masses should ignite the mixed atomic fuel shell at the 3.5 solar mass depth, which would heat, compress, and ignite the ionic chrodeuterium layer at the 5.25 solar mass depth, leaving a chrohydrogen ion remnant core of between 2.6 and 3.5 solar masses, and should expel between 2.6 and 3.5 solar masses, including most of the overburden.

Chrotonic atoms and ions would energetically decay into first family particles immediately upon contact with the interstellar medium. Neutronic/antineutronic leptons would balance the decays. What remains is a spinning liquid ionic chrohydrogen and/or chrodeuterium core, which creates a powerful dynamo. It is called a pulsar, and it is surrounded by thin shells of increasingly less dense degenerate hadrons and hybridons, followed by an interregnum shell of lambda particles, culminating in a layer of first family neutrons. These peripheral shells would insulate the chrotonic core from the destabilizing effects of the first family energy background that is found in the interstellar medium. ⁷ It is probably no coincidence that second family atomic chrohydrogen, consisting of a chroton and an omega- (3.5 GeV +1.5 GeV =5 GeV), is the mass equivalent of two seutrons (2.5 GeV +2.5 GeV =5 GeV). Similarly, its counterpart, third family atomic trydrogen, which consists of a troton and a theta-(355.5 GeV+13.5 GeV=369 GeV), Is the mass equivalent of two beutrons (184.5 GeV+184.5 GeV=369 GeV). The decay channel of atomic chrohydrogen is two seutrons. The decay channel of atomic trydrogen is two beutrons. The decay channels of chrohydrogen and trydrogen atoms made a serendipitous appearance in this presentation solely as a consequence of the proportional relationships between the hadronic masses set forth above in A PROOF OF THREE FAMIILIES BY SIMPLE ADDITION.

### Binder, Breaker, Candle Maker

In 1997, Charles Bailyn, of Yale University, calculated the masses of seven black holes within binary systems of the Milky Way. The conventional wisdom was that black holes should range from three to dozens of solar masses, yet six of the seven weighed in at almost seven solar masses each, and the seventh at between ten to fourteen. What could account for these findings?

A pattern is emerging suggesting a spatial relationship between the mass and the density of second family hadrons within the geometry of a massive sphere. Envision quantum levels of allowable star contraction, where only discrete increases of density, each corresponding to a specific hadron rest mass, are permitted. This is analogous to the atomic electron orbital model, but instead of a reversible exchange of photoelectronic quanta, we have one way stellar mass increases, in discrete jumps, from a lighter second family element to a heavier second family element, limited only by the speed of sound at the stellar core.

Although its mass within the spherical core is divided into three distinct layers, a collapsing gas star of between 7 and 14 solar masses should be massive enough to achieve simultaneous ignitions at the discontinuities of all three density discontinuities, ie: at the 3.5 solar mass atomic chrohydrogen/ionic chrodeuterium core interface, at the 5.25 solar mass ionic chrodeuterium/ionic chrohydrogen interface, and at the 7 solar mass ionic chrohydrogen epicenter. Although all three chrotonic fuels should fuse to chrohelium at the same time, the fusion would begin at the interfaces of those discontinuities, to propagate inwards and outwards, within those three distinct density layers, except only outwards from the epicenter.

Therefore, a brief period of time should intervene between the onset of fusion at those three loci and the termination of fusion throughout the core. During this interval, the energy imparted to the impact junctures of the colliding shock wave fronts would drive pairs of chrohydrogen ionslatoms to fuse into higher second family elements and beyond.

When chrohydrogen ions (2×3.5 GeV) fuse to ionic chrohelium (7 GeV), at the 7 solar mass epicenter, there is an instant when the chrohelium must form into physical particles. At that instant, the density at the 7 solar mass liquid epicenter exceeds the resistance of each 3.5 GeV chroton (one charm and two strange quarks) within each chrohelium ion, as the ambient kinetic gravitational energy augments the potential energy of the least massive quark within the next most massive hadron.

The least massive hadron beyond the chroton is the eta hybridon (one charm, one strange, and one bottom quark (1.5 GeV+0.5 GeV+4.5 GeV=6.5 GeV). It is created when one strange quark (0.5 GeV) energetically absorbs the mass equivalent of 1 GeV, within the confines of a chroton, and metamorphoses into a bottom quark (1.5 GeV), because that requires the least possible quantum increase of mass to the next most massive quark.

At the density of an eta hybridon, the speed of sound at the 7 solar mass epicenter would then surpass the speed of light, which is prohibited. Therefore, the epicenter implodes, after momentarily being transformed into a springboard that is driven into supernova oblivion by the pulse of rebounding energy imparted to it from the recoiling overburden. What remains is a spinning black hole of 7 solar masses, surrounded by an expanding torus of 7 to 14 solar masses that consists of chrohelium ash, which then decays in a cascade of neutrons, protons, and electrons upon contact with the first family interstellar medium.

In a first family stellar environment, beryllium is so unstable that it decays almost immediately. However, chroberyllium does not suffer from this instability, because seutrons do not decay into chrotons, as neutrons decay into protons. In a stellar remnant environment, when pairs of chrohelium nuclei (2×7 GeV) fuse into stable chroberyllium (14 GeV) at the epicenter of a 14 solar mass star, there is an instant when the chroberyllium must form into physical particles, at the same time that chrohydrogen is fusing to chrohelium particles at the 7 solar mass level. At that instant, at the epicenter of a collapsing gas star that is between 14 and 28 solar masses, the density would exceed the degenerate resistance of each chrohelium ion at the 7 solar mass level and of each chroberyllium ion at the 14 solar mass level.

When this occurs, ambient kinetic disordered gravitational energy would augment the ordered potential mass/energy of the least massive quark within the next most massive hadron. In this case, the 6.5 GeV eta hybridon should form at the 7 solar mass level, while at the 14 solar mass level, the least massive hadron to form beyond the eta hybridon is the epsilon hybridon (one charm and two bottom quarks, at 1.5 GeV+4.5 GeV+4.5 GeV=10.5 GeV). It is created when the remaining strange quark (0.5 GeV) energetically absorbs the mass equivalent of 1 GeV, within the confines of an eta hybridon, and metamorphoses into a bottom quark (1.5 GeV), because that requires the least possible quantum increase of mass to the next most massive quark.

At the density of second/third family hybridons, the speed of sound at the core would surpass the speed of light, which is prohibited. Therefore, the core implodes, after momentarily being transformed into a springboard that is driven into supernova oblivion by the pulse of rebounding energy imparted from the recoiling overburden. What remains would be a spinning black hole of 14 solar masses, surrounded by an expanding torus of 14 solar masses or more, consisting of chrohelium/chroberyllium ash that decays in a cascade of neutrons, protons and electrons upon contact with the first family interstellar medium.

The transzeta gap (box B) eliminates the top quark as a factor in the manufacture of hybridons in remnant stars. Therefore, the most massive possible stellar remnant hadron would be the third family theta-(three bottom quarks at 3×4.5 GeV =13.5 GeV).

One may be tempted to predict the existence of a first family star so massive that it would retain enough of its substance in a collapsed stellar remnant, after solar wind mass shedding, to create the next most massive permitted chrotonic element, chrosilicon (2×14 GeV=28 GeV). Theoretically, triron (2×28 GeV=56 GeV) is the last remaining permitted chrotonic element. Regardless of whether a 28 solar mass black hole or a 56 solar mass black hole is ever discovered, the ultimate failure to observe any stellar black hole mass between 3.5-7-14-28-56 solar masses, and none greater than 56 solar masses, would prove that mass values double in stellar black holes.

It appears that the second family of matter is the mediator between the entropic universe and the antropic universe.

### Top to Bottom

Now to the mediation role of the third family viv-a-vis our first family world. Conventional wisdom holds that present day first family matter gradually precipitated out of an energy/particle “soup”, which constituted the expanding fireball of the big bang. In that first microsecond, the energy was so intense that quarks roamed freely, until the energy dispersed and the fireball cooled, so that the free roaming up and down quarks could combine into protons and neutrons, it is said. It is also said that, a few hundred thousand years later, positively charged protons then combined with negatively charged electrons to form the first neutral atoms, at which time radiation separated from matter, an event permanently imprinted upon the gradually cooling universal radiation background.

To play upon words, the Author refers to this process as the down-up model, and continuing the play on words, proposes the top-bottom model, which draws upon the findings of experimental particle accelerators, where massive proton/anti-proton pairs are directly created out of energetic collisional events, sans the intervention of separated quarks.

Contemplate the expanding big bang fireball, in thermal equilibrium. At the first instant of the Expansion, radiation energy filled all of space, which was gravitationally curved in upon itself by the mutual attraction of the mass equivalence of that energy. The fireball was an expanding black hole that confined the radiation which, together with the momentum of the vacuum energy within space itself, drove the Expansion.

At that first instant, all radiation energy existed at the highest frequency attainable by radiation, whatever that limit is (probably the fundamental value of a constant of nature). Since expansion is a cooling process, the frequency of that radiation diminished over time, even as its wavelength increased. Yet, at any particular moment, all of the radiation which filled all of space, equally at all points in space, was at the same frequency and wavelength.

At all relevant times subsequent to that first instant, radiation everywhere maintained itself at its lowest energetic state, a soliton. The soliton is a wave form that constantly retains its wavelength as it moves, because of some physical, coherent, and constant constraint upon its movement. The most common example of a soliton is a standing tidal wave, which maintains the height of its crest as it moves down an estuary because its retaining channel has a specific curvature and depth that correlates exactly to the specific height of the wave. The geometric curve of the channel and the energy originally imparted to the wave determine its form and wavelength.

So too, the curved geometry of space-time, within the expanding black hole of the fireball, constrained the radiation to take the form of a soliton wave. The wavelength of the soliton was maintained, at every point in space, at any particular instant, by the curved shape of the constraining black hole, even as space itself was expanding everywhere from each point in space-time. As the size of the expanding black hole increased smoothly with time, both the volume of space-time, and the wavelength of the universal background radiation, increased correspondingly. However, the wave form of the radiation remained that of a soliton, with incrementally distinct wavelengths that lengthened, from instant to instant, in a continuum, throughout the expanding fireball.

The density of the radiation, at that first instant of the expansion, was equal to the greatest density that radiation is permitted to attain and still be radiation, probably a constant of nature. The specific rest mass of any particle has an equivalent energy value, which, at a specific point on the energy gradient of the ambient energy background, will cause it to precipitate out as a particle, ie: it will spontaneously appear whenever the energy background attains the particular wavelength corresponding to the equivalent rest mass of that particle.

It might be useful to think of a particle of matter as solid energy, “frozen” in solitonic form, with each specific particle at its own discrete quantum energy level. This mass/energy relationship is analogous to the quantum energy levels of the electronic shells which surround neutral atoms, except that the solitonic wave function of any particular hadron, quark, or lepton corresponds to its own quantum rest mass/energy level.

The stability of any particle, or antiparticle, depends upon it having a whole unit electromagnetic charge of +1, −1, or 0, and upon the maintenance of the background energy within the equivalent rest mass range of the family to which that particular particle is a member. The stable lepton has a charge of −1. In contrast, the ⅓ fractional charges of unstable quarks require them to triply combine into nucleons for stability. Mesonic couplings are unstable because of quark/antiquark interaction. If the energy background attains a value above or below the rest mass energy range corresponding to the family of any particular particle, the exposed particle will revert (decay) into its energy/wave equivalent. On the other hand, any specific particle will precipitate out of the energy background once the energy equivalent of its specific rest mass is attained. The more massive the particle, the shorter its lifetime and the less specific that mass value will be, as a result of quantum uncertainty, but the mass will still lie within a range of potential energies called the mass band width, which has a peak average mass value and a corresponding mass uncertainty.

### Steplfation

The general consensus is that only three families of matter exist in nature. This consensus originally grew from theoretical conclusions drawn from the observed astronomical mass fractions of the lightest elements in the universe, mostly helium 4, which have an indirect dependence upon the number of types of neutrinos. Each type of neutrino is associated with a different family of elementary particles. Later, measurements taken in particle accelerators arrived at similar conclusions based largely upon two inferences: that all neutrinos possess mass, and that there is a relation between the average mass value (band width) of the Z° boson, which in turn depends upon the decay lifetime of the Z° boson, and therefore upon the number of varieties of massive neutrinos in the decay channels of the Z° boson. Again, this presumably places a limitation on the total number of families of matter to which all neutrino varieties could belong, because each family of matter has one neutrino as a member. However, if neutrinos are massless, or if neutrino mass were a variable, and not a constant of nature, as we shall explore, one could not reliably enumerate family members based solely on the number of neutrino varieties that contribute to the bandwidth of the Z°.

That neutrinos possess mass is based largely upon observations of the neutrino flux emanating from the sun, which conflict with predictions based upon the Standard Model. Because the sun is not very massive, it is capable of producing electrinos only, and is prohibited from producing muinos or tauinos, theoretically. For many years, there has been a two-thirds shortfall in the total number of observed solar neutrinos, as compared with the numbers predicted in the Standard Model. These measurements were taken in observatories having detectors which utilized highly purified water (H₂O), but which were sensitive to electrinos only. Recently, in a detector using heavy water (D₂O), which is sensitive to all three neutrino flavors, the missing neutrinos appear to have been found. By process of elimination, it was deduced that the missing neutrinos must have been muinos and/or tauinos (it is not yet possible to discriminate between the two from these data), so that most of the electrinos, which were originally created in the sun, must have “oscillated” into the other two flavors on their trip to the Earth. By implication, neutrino oscillation indicates that all neutrinos possess mass, it is said. Of course, if neutrino oscillation is not mass dependent, then there is no conflict with the Standard Model, and neutrinos do not, in fact possess mass.

Recall that each massive particle of the first family of matter (including a putatively massive neutrino) has a more massive counterpart in each of the other two known families of matter. In this case, the tauon is more massive than the muon, and the muon more massive than the electron. Logically, a massive tauino should be more massive than a muino and the muino more massive than the electrino.

To oscillate is to alternate, to change between, to transform into. When every massive particle transforms into a more massive particle(s), it is required that there be some necessary accretion of mass or addition of energy to broker the transaction. When a more massive particle transforms into a less massive particle(s), it is called decay, not oscillation, and the decay of a less massive particle into a more massive particle is forbidden.

Therefore, it appears difficult, in the absence of a contrary explanation, to square the notion that a solar neutrino can “oscillate” into a more massive counterpart, without identifying the source of any increase in its masslenergy on the short trip to the Earth. Even more puzzling, experiments between atomic reactors, which generate neutrinos (only electrinos?) at specific points on the Earth's surface, and neutrino detectors located at other points on the surface, seem to reproduce the same results. The puzzle is that the energies generated in an atomic reactor are considerably less than those in the sun's core, and the distance to a detector is a much shorter trip. What, then, is the minimum time/distance oscillation of a neutrino, and is; there a relation between oscillation and the ambient energy at neutrino birth?

Nevertheless, it has been advanced that the neutrino is a composite of three mass “states” which can change as it travels. The proposition that neutrino mass is only a potential quantity at birth, subject to actualization at a later time or event, may resolve the conflict with the Standard Model, which holds that neutrinos have no mass.

Assuming arguendo that neutrinos do indeed possess mass, the Author would like to explore the proposition that neutrino mass is integrated with the mechanism that controls how matter permanently disengages from antimatter. The number of families of matter has significance regarding the modality of greater than light speed expansion, upon which current theories of inflation⁸ depend. In the event that there have existed other families of matter beyond the three already known, there must have come a time when unimaginably dense proton-like hadrons, paired with their antiparticle equivalents, spontaneously precipitated out of the expanding radiation of the Big Bang, (as in a terrestrial particle accelerator, when collisional energies reach the rest mass of the proton, and proton/anti-proton pairs spontaneously spring into existence). Given the previously described relationship between the masses of the known fundamental particles, the masses of these ultra massive hadrons were most probably that of some multiple of the rest mass energy of the bottom quark, 4.5 GeV, which appears to be mathematically related to the rest masses of all known hadrons and weak bosons. It is not likely that relatively less massive, free roaming, quarks would have fused in the transzeta environment of the Expansion (over 90 GeV), where the unit volume of mass/energy was decreasing and fission ruled the waves. Rather, it is more likely that hadrons appeared fully formed, and then decayed into multiple, lower mass, particles when the ambient energy background cooled past their family energy range. ⁸ An exponential expansion of spacetime, originally conceived In 1917 by Willem de Sitter, the term “Inflation” was coined and popularized by Alan Guth, of the Massachusetts Institute of Technology, and published In the Physical Review, in January of 1981. Recently confirmed by measurements of the universal radiation background, Inflation is the only theory which resolves the cosmological contrasts between the original smoothness and curvature of the Big Bang, and the present lumpiness and flatness of the observed universe. Still unresolved Is what overcame the enormous gravitational field that was necessarily associated with the Immeasurably dense initial environment present at the the expansion. An attempt to arrive at this resolution is one of the goals of this paper.

Those postulated super massive hadrons and antihadrons must have been composed of quarks and antiquarks of +⅔ and −⅓ charge. When they first precipitated out of the fireball, they probably consumed all of the energy available, with no background radiation left over (please accept this assumption for the time being). Each hadron was then in direct physical contact with its antihadron twin, and each of these pairs was in direct physical contact with a sibling duo. At this singular point in time, the entire fireball was like an immense nucleus, with absolutely no space separating each hadron. Therefore, the distance between each particle, or antiparticle, was smaller than its equivalent deBroglie wavelength, resulting in a state of Bose-Einstein degeneracy.

A particle of matter, or antimatter, can be considered as a kind of battery which consists of, and stores, potential energy, kinetically releasing it through radioactive decay or particle annihilation. In this context, all of the radiation energy contained within the initial fireball was converted from kinetic to potential, in the form of nucleonic particles, with no kinetic energy left over. However, this condition lasted picoseconds or less, until the particle/antiparticle pairs annihilated each other, at which time all of the potential energy was converted back into the kinetic form, ie. radiation.

While matter and antimatter particles created and annihilated each other immeasurably fast, they did not do so immediately, and during that briefest of times, the expansion of space from every point within the sphere had also proceeded, however quickly. Because individual quarks cannot be separated, any increase in volume during the interim of particle creation occurred exclusively between nucleons, resulting in radiation free voids interspersed with nucleons.

However, each new cycle of particle creation/annihilation resulted in a subsequent generation of more numerous, but less massive, hadrons. They not only filled the spaces previously occupied by the just annihilated, but more massive, hadrons, they also dispersed into the newly created voids, because there was no place else to go. At each annihilation phase of the particle creation/ particle annihilation cycle, any discontinuities in the equilibrium were erased by the radiation.

As the sphere expanded, the radiation within it cooled, and its uniform wavelength increased correspondingly, even as the solitonic wave form was maintained within the curved geometry of the expanding sphere, albeit at each successively increased wavelength. Each nucleon/anl:inucleon reaction was identical in nature, individually and collectively, and the reaction products were sequentially equal, involving only transformations at a uniform level of energy, into the same kinds of matter, albeit at successively lowered masses. All sequential transformations involved only one specific family of matter, in turn, each taking exactly the same amount of time everywhere for creation and then for annihilation, and each producing only one specific frequency at a time after each annihilation, at each local point in space. It follows that, at any specific moment, the resulting radiation was everywhere at only one specific energy. In this scenario, all reactions were equal and ongoing everywhere, but temporally and spatially local, so that it was not necessary for radiation to “communicate” in order to achieve thermal equilibrium everywhere, at the same time. This part of the expansion occurred in classical time, during particle/antiparticle annihilation.

Another kind of expansion occurred during particle creation. This kind of expansion occurred in quantum time, that is, instantaneously. The fireball was an expanding sphere of finite size, with each incremental increase in total volume remaining finite, from moment to moment, as it expanded. The expansion also proceeded equally from each point within the sphere, in a seamless time continuum.

The mass equivalent of the total energy of the soliton radiation within the sphere was always equal to the total rest mass of the nucleons created during each kinetic-potential-kinetic cycle. Total mass/energy was therefore conserved. However, the precipitating nucleons increased in number as the background radiation decreased in frequency, because the mass of each successive nucleon had a correspondingly lengthened wavelength of equivalent energy, and because particles always decay into less massive particles. Although each successive mass/energy cycle resulted in an equally massive generation of hadrons, each such generation contained less massive, but more numerous individual quarks. For example, the decay of one relatively massive bottom quark (4.5 GeV) into one less massive chroton (3.5 GeV) with three quarks, and one less massive neutron (1 GeV) with three quarks, results in a net increase of five lower mass quarks. Yet, each quark still requires approximately the same distance of separation from the others.

The requirement to maintain the same approximate distance between individual quarks translates into the instantaneous need for additional local room everywhere to accommodate the additional quarks. This necessitated an instantaneous gross increase in the total volume within the sphere, ie: it took more room, all at once, to hold the same amount of mass due to the creation of a greater number of less massive quarks. Therefore, the density of the soliton radiation source, per unit of volume within the sphere, was always greater than the density of the resulting nucleons, after factoring in the dilution in density from the ambient expansion. To put it another way, and allowing for the expansion of the fireball, the density of the resulting nucleons would have equaled that of the radiation source, but for the increase in the room necessary to accommodate the more numerous, longer wavelength, quarks and the spaces between them. Total local particle formation outpaced the confines of the classical expansion of the sphere.

Each particle was created out of that quantifiable volume of radiation which was located at the site of the creation of that particle. This requires an increase in the local volume of space in order to accommodate the formation of each nucleonic quark in the same location as the source of that radiation. The increase in local volume everywhere resulted in an expansion of the entire sphere, from every point in space, at the same quantum instant, even as the Expansion was contemporaneously proceeding in classical time.

Therefore, each kinetic.-potential-kinetic cycle resulted in a separate mini-expansion, because each successive kind of particle precipitated out of the background radiation in sequence, at a specific, albeit lower, rest mass/energy than its predecessor. As a consequence, the expansion was not smooth, but was punctuated by quantum “jumps”, analogous to the jumping of electrons between the energy shells of atoms. The Author refers to this process as stepilation, and offers it as a plausible quantum mechanism to account for faster than light expansion.

### The Emperor's Bose—First Light

Even if it is confirmed that there have always been only three families of matter, the energy of the entire fireball must have eventually cooled down, through expansion, to a uniform value of 355.5 GeV, the rest mass of the troton. From every point in space, and at the same time, fully formed trotons (and putative antitrotons) precipitated out of the universal background radiation, as opposed to the emergence of top and bottom quarks that later coalesced into trotons. The expanding sphere consisted of a contiguous ball of troton plasma.

At this instant, since the speed of sound in a gas did not exceed the speed of light for the first time, particles of matter could permanently form without being required to decay. This was also the period when matter quickly began to dominate antimatter. Actually, matter trotons and antimatter trotons should have spontaneously appeared in pairs (2×355.5 GeV) but antitrotons were forbidden to form because of two characteristics of intermediate vector bosons. The first has to do with the physical relationship between the rest masses of weak bosons and the energy range of the third family, and the second has to do with the nature of the mechanism by which weak boson particles mediate the transformations of other particles.

Current efforts to solve the mystery surrounding the dominance of matter over antimatter have concentrated on violations of symmetry within the Standard Model having to do with charge/parity reversal, or CP. However, total CP violation projected from the Standard Model is insufficient to account for the excess of matter in the universe. It also appears that the weak force violates CP.

In charge conjugation, or C, the quantum numbers of every particle are transposed into those of its antiparticle. If the laws of physics are the same in the real world as in the charge conjugated world, then C symmetry is achieved. If C symmetry has been achieved, then left handed charged particles should behave exactly as right handed charged particles. Therefore, charge symmetry is violated in weak interactions because antineutrinos are only right handed, never left handed. Since antineutrinos interact only weakly with all other particles, this asymmetry is associated with the weak force. It appears that the weak force violates C.

In parity reversal, or P, when an object and its mirror reflection are rotated one hundred eighty degrees about their axis perpendicular to the mirror, parity reverses the vectors associated with the object. If the laws of physics are the same in the real world as in the parity reversed world, then P symmetry is achieved. If P symmetry has been achieved, then left handed particles would decay exactly as right handed particles. In a 1957 experiment, Chien-Shiung Wu, of Columbia University, demonstrated that only left-handed particles can decay through the mediation of weak interactions, even though all neutrinos are right-handed, never left-handed. Since neutrinos interact only weakly with all other particles, this asymmetry is associated with the weak force. It appears that the weak force violates P.

Because the rest masses of the Z° and W± weak bosons (90 GeV-81 GeV) are “nested” entirely within the energy range of the third family of particles (355.5 GeV-3.5 GeV), it was necessary that the total amount of available radiant energy (2 x 355.5 GeV) of the expanding fireball be utilized in the production of not only the trotonic hadrons, but also of the intermediate vector bosons, at the same time.

Weak boson particles and matter particles differ in certain fundamental respects, but share similar characteristics in others. Quarks and leptons (matter) have half-unit integer spins (spin ½), in contrast to weak bosons (non-matter) which have whole-unit integer spins (spin 1). Bosons have electromagnetic charges of whole units (the Z° charge 0, the W+ charge +1, the W− charge −1, and the photon 0 charge). Leptons also have whole unit charges (the electron, the muon, and the tauon −1 charge each), and each lepton has an associated neutrino, 0 charge. Although quarks have fractional electromagnetic charges of +⅔ and −⅓, when three quarks combine into a hadron, the resulting hadron possesses the same whole unit electromagnetic charge as does a boson or a lepton (+1, −1, or 0).

Quarks and leptons obey Fermi statistics and are called Fermions. Matter particles consist entirely of Fermions. Fermions have an antiparticle equivalent. Weak boson particles obey Bose-Einstein statistics and are the carriers of the weak force. Weak bosons have no antiparticle equivalent. For example, there are antineutrons, but there are no antiZ° bosons.

Despite their differences, it is apparent that Fermions and weak bosons are inherently connected in certain fundamental respects, if for no other reason than that they decay into one another. It is predicted in superstring theory that bosons and Fermions are unified at extreme energies. Weak bosons, quarks, and leptons are the only fundamental particles that exhibit mass in the Standard Model, and gravity acts equally upon each kind of massive particle.

Within the context of quantum mechanics, Bose-Einstein statistics allow whole unit integer spins of like particles to coalesce in such a way, and under certain conditions, that they form a stable substance called a BoseEinstein condensate. For such particles (eg. alpha particles), which are stable only at first family rest mass/energy densities, those conditions are present only in a dilute gas, and only at temperatures approaching absolute zero. Bose-Einstein condensation has been demonstrated, under those specific conditions, because Bose-Einstein statistics permit identical weak bosons to attain a stable particle state when their deBroglie wave functions overlap.

It is the position of the Author that weak boson particles, having rest masses of 90 GeV-81 GeV, may also achieve stability under other specific conditions which allow their deBroglie waves to overlap. such conditions must have been present when weak bosons emerged from the expanding fireball, in quantum physical contact with each other and with stable third family nucleons, and while the weak bosons were nested within the constant rest mass/energy range of the third family (355.5 GeV-3.5 GeV).

Trotonic nucleons and weak boson particles, having emerged at the same time and at the same place, and within the same constant energy background, would have maintained physical contact between each other for the same reason that each attracts the other during observed nucleonic transformations, ie. weak bosons are the carriers of the weak force. In this situation, quantum physical contact with a stable troton, beutron, or theta- should provide the necessary environment to stabilize a weak boson particle.

At energies above and below the specific rest mass energy range of the third family (355.5 GeV-3.5 GeV), weak bosons can not transform from waves to particles. When not in particle mode, weak bosons mediate the radioactive decay of all other particles, including matter/antimatter transformations, within the diameter of a quark or a lepton, ie. entirely within the confines of the interacting fundamental particles. Under those conditions, the transformations are exclusively determined by the constituent characteristics of the interacting particles only. One such characteristic requires the equal production of matter particles and antimatter particles to balance the transformations in all particle decay.

The Author proposes that, when a weak boson is in quantum physical contact with a stable third family hadron, which is bathed in the energy range of the third family, the particles merge, and the weak boson component attains a stable particle mode. The composite boson/Fermion particle, a bosion (Author's choice), thereby acquires stability, but it can then mediate radioactive decay only at the perimeter of the merged particle, because a weak boson particle may not occupy a physical position within any other kind of fundamental particle, such as the quark component of a hadron. That is, the stable weak boson particle component of a bosion is still capable of decay mediation, provided that quantum physical contact is maintained between the “perimeter” of the bosion and that of the transforming fundamental particle(s). Under those conditions, a bosion acts like a passive catalyst.

As a catalyst, a bosion can be considered a template upon which other particles interact, without the bosion actually participating in the interactions. The Author proposes that, as a catalyst, a bosion can only mediate those transformations that result in an end product that it, itself, is capable of attaining. Therefore, a stable weak boson particle, in bosion catalyst mode, is incapable of mediating the antimatter transformation of any other particle, because it, itself, lacks an antimatter component.

Although antitrotons were therefore prohibited from forming, it is nevertheless mandatory that an equal, but oppositely charged, antimatter component be created whenever matter is formed. Therefore, for every troton formed in the presence of a catalytic bosion, the Author proposes that an antineutronic lepton balanced the transformation. In this manner, two trotons of matter were created together with an antitauino, in lieu of a troton and an antitroton, so that total charge was conserved.

There are reasons why antitauinos are permitted during these transformations, and antitrotons are prohibited. Because weak boson particles do not operate within any other particle, including neutronic leptons, and because neutronic leptons, with or without mass, interact so weakly at the perimeters of all massive particles, including massive weak boson particles, the chance of a bosion mediating the transformation of a massless, or massive, antitauino is vanishingly small. As noted before, it also appears that the weak force violates the charge/parity reversal (CP) of neutronic leptons.

### A Bridge Over Troubled Ethers

Also noted before, at a background energy of 355.5 GeV, trotons and other nucleons (but not antinucleons) precipitated out of the radiation of the expanding fireball. Because the energy range of the weak bosons (90 GeV-81 GeV) lies entirely within the third family energy range (355.5 GeV-3.5 GeV), it is required that weak boson particles form at exactly the same time and place as third family trotons. Although fifty percent of the total energy (2×355.5 GeV) that would have been necessary to create one troton of matter, and one putative antilroton of antimatter, did actually produce one troton of matter (355.5 GeV), consisting of one 4.5 GeV bottom and two 175.5 GeV top quarks, the other fifty percent of the energy did not produce an antitroton, and instead produced one beutron of matter (184.5 GeV), consisting of one 175.5 GeV top and two 4.5 GeV bottom quarks, plus the weak bosons, cumulatively at 171 GeV (the 90 GeV Z° and the 81 GeV W±). In this manner, total mass was conserved at 2 x 355.5 GeV and, in lieu of the putative antitroton and the putative antibottoin quark, two antitauinos balanced the transformations.

When all particles are formed at the same time, in discrete quanta (each has a specific rest mass energy equivalent), out of the same source of uniform radiation, and when the cumulative rest masses of all of those individual particles are equal to that of the original gross energy source (Albert Einstein's E=mc², it is implied that when those particles are created, all of the available radiation energy goes into particle formation, with no radiation energy remaining in the background.

Since the weak bosons were created at the same point in place and time as the Fermionic trotons and beutrons, each respective boson was attracted to a Fermion of opposite charge, and the bosion was born. The positively charged troton was bound to the expressed negative pole of the compound bipolar W±, the negatively charged theta- was bound to the expressed positive pole of the compound bipolar W±, and the neutral beutron was bound to the neutrally charged Z°. In this manner, the fireball was transformed from a charged trotonic plasma into a sphere of neutrally charged bosions. This was the era when matter permanently separated from radiation, and the fireball was no longer a “black” hole. The fire (radiation) had left the ball. That event has been imprinted on the universal background radiation to this day.

A neutrally charged bosion particle took shape (box A), which we shall call the weasion (711 GeV), consisting of a troton (355.5 GeV at +1 charge) in the center, surrounded by a beutron shell (184.5 GeV at 0 charge), which was then surrounded by a Z° shell (90 GeV at 0 charge), and last by a W± shell (81 GeV with expressed −1 charge). The W−, being the least massive particle, had the longest wavelength, and was therefore still capable of mediating core troton interactions from the perimeter of the composite particle, because it maintained contact with the shortest wavelength troton, through the intervening particle shells, by quantum tunneling.

Bosions are a new class of neutrally charged composite particles (according to the Author), and they act as a bridge between the chaotic instabilities that were present in the era of matter/antimatter annihilation, and the stable matter era of the present. The other members of the class include the theasion, a negatively charged theta- bound to the positive pole of the W± component of the weasion (724.5 GeV); the treabion, a neutral beutron and a positive troton bound to the negative pole of the W± (621 GeV without the Z°); the theabion, a negatively charged theta- bound to the positive pole of the W± component of the treabion (634.5 GeV); the treawion, a positive troton bound to the negative pole of the W™ (436.5 GeV without the beutron or the Z°); the theawion, a negatively charged theta- bound to the positive pole of the W± component of the treawion (450 GeV); the thearion, a neutral beutron and a negative theta- bound to the positive pole of the W± (279 GeV without the Z°); and the theation, a negative theta- bound to the positive pole of the W± (94.5 GeV without the beutron or the Z°).

So long as it remains in the embrace of some third family hadron, including that of the theta-, each bosion maintains its viability. The decay of any particular bosion is dependent upon the strength of the binding energy of its constituent weak boson(s), and each weak boson bound into a bosion is subject to becoming unbound at collisional or background energies higher than the energy binding it to its respective bosion.

Bosions are the vehicles that transported our world of matter out of the matter/antimatter chaos of the maelstrom. They remain stable, some to this day (according to the Author), provided only that the binding energy of the weak boson component(s) of any particular bosion is not exceeded. This implies that, at the moment of bosion creation, the background radiation was lower than such binding energy, and reinforces the proposition that all available background radiation, at that moment of intense energy, was subsumed in particle formation.

The breaking point of bosonic particle bonds probably lies within the energy range of the bottom quark, at the low end, because it must be more than 3.5 GeV, when the chroton would precipitate out of the background energy. It must also be less than 4.5 GeV, when the bottom quark would materialize out of a charm quark, combining with another charm quark and a strange quark to form an eta hybridon, the least massive hadron beyond the chroton.

It has been reported that the atmosphere of the Earth is being daily bombarded by mysterious point-like “cosmic ray” sources of rare, but immeasurably high, gamma rays. Each explosive event has been described as . . . “a proton with the impact of a well thrown rock”. Just imagine the effect of repeated collisions between a theasion (or other neutrally charged bosion) and the nucleons of the gas molecules within the Earth's atmosphere.

A theasion, for example, contains the mass of more than 750 protons, and air molecules would add more nucleonic mass to the mix. Repeated collisions with molecules in the atmosphere would raise the temperature of the constituent weak boson particles above their binding energies. Once “unbound”, the weak bosons would lose their stability, and would then decay into particles of matter/antimatter. Unprotected from the constant background energy level of the first family, the remaining third family nucleons would promptly experience matter/antimatter decay in the presence of non-particle weak bosons which have no antimatter component. At the Earth's background energy, the non-catalytic weak force would mediate these decays, operating entirely within the diameters of the decaying particles. The decay products of matter and antimatter would then create the observed cascade of particles and energy which funnel down, and even burrow into, the surface.

One might ask, how could ancient and cosmologically distant theasions, or other bosions, survive to reach Earth at the present time? One reason is that bosions are electromagnetically neutral, and are therefore unaffected by the relatively weak magnetic fields of intergalactic space that might otherwise accelerate them to high collisional speeds, or that might guide them into collision with some electromagnetic source (a la aurora borealis).

Another reason is that their numbers have been diluted relative to the increased volume of space during the intervening billions of years of the Expansion. Compared to the vast number originally created, relatively few bosions are observed to impact the Earth partly because their numbers have been reduced by the cumulative effects of interstellar processes. Also, the more massive an interstellar bosion might be, the less numerous it must be, because it would have been that much more likely to have been gravitationally bound into, and then degraded within, a passing stellar core. This would explain why so few of the most energetic cosmic ray impacts in the atmosphere have been observed.

Although bosions may constitute super massive cosmic rays, they would have had to emanate from sources within the primordial stages of the Expansion, and at extreme intergalactic distances relative to the present position of the Earth. Observations of high energy cosmic ray atmospheric collisions confirm that they are not creatures of local origin because they are omnidirectional and too energetic to be explained by galactic sources. Therein lies a conundrum, because it has been mathematically proven that collisions between cosmic rays and even the relatively weak primordial photons of the universal background radiation would dissipate the collisional energy of any cosmic ray, including that of a bosion.

Statistically, most intergalactic collisions must be glancing, and any isolated glancing impact would not be likely to break bosonic bonds before the heat of the collision were dissipated, even as it slowed the speed of the bosion. It is likely that the deceleration caused by energy dissipation is a major reason for bosion longevity. For example, an isolated collision between a super massive, but sufficiently lethargic, bosion and, say, an intergalactic proton, would not necessarily be energetic enough to dislodge a weak boson from its matrix before the collisional energy were dissipated, even if the impact were head-on.

The solution to the puzzle is that most of the energy in observed atmospheric discharges, although precipitated by particle collisions, is generated not by the collisions themselves, but by boson decay and the resulting matter/antimatter disintegration of third family nucleons. To initiate boson decay, only the specific bosonic binding energy attendant to any particular bosion needs to be overcome. The fiery entry of meteoric dust particles in the atmosphere, through repeated collisions with air molecules, amply demonstrates that the required energy is available to disintegrate a cosmic ray bosion. On a small scale, the effect would be like the detonation of an atomic bomb by a conventional explosive trigger.

### The Blastoma Phase

There was a brief time when particle birth roughly resembled initial biological cell division, with the emphasis on blast. That is, before particles were differentiated into the second and first families of matter, several varieties of third family/second family/bosion particles were formed. All of these new particles were created in quick succession, out of the same mass/energy source, and within a discrete volume of space, ergo the blastoma metaphor. It might be helpful to think of bosions as the generic “stem” particles from which all particles of the standard model evolved, ie: there is no primary or composite subzeta particle that is not a channel of bosion decay (box A and box B).

As we have reasoned, the first particles of enduring matter to have precipitated out of the fireball were the bosions. At that time, the entire fireball was like an immense nucleus of uniform density, with each weasion physically touching another, and with no space or radiation existing between them. At that instant, the fireball was a homogeneous sphere, in thermal equilibrium. All weasions were equidistant from one another because there was insufficient time for gravity to squeeze them into a decay mode before the emergence of two sources of energy that resisted catastrophic collapse. The sources were boson decay, at first, and then nucleogenesis.

As there was no ambient radiation at that instant, there was little outward pressure to retard the inward crush of gravity, except for the expanding momentum of the vacuum energy of space itself, which was insufficient to the task at that time. The Expansion continued to proceed equally from each local point in space and time, as it still does. However, each local point in space was then occupied, everywhere, by a contiguous particle of matter that was as equally massive as every other particle of matter. Therefore, the effect of gravity, everywhere, was to act instantly and simultaneously upon each local particle of mass, as it still does, in a graduated increase of attraction, in a seamless continuum, from the periphery of the sphere to its center⁹. ⁹ Please withold judgment regarding the controversial concept of the existence of a center to the Expansion, until after reviewing the section, “A CENTRAL THOUGH”.

The contemporaneous emergence of abutting weasions throughout the sphere immediately threatened gravitational collapse. However, due to the characteristics of the constituent particles of each weasion and their interactions, together with gravity which was greater at the center than at the periphery, a nucleogenetic ballet began to unfold upon the cosmological stage.

At the very instant after the contraction, in the epicenter of the central region where the effect of gravity was the strongest, the binding energies of the weak bosons were quickly overcome, and the bosonic bonds broke. The weasions differentiated into their component parts. First the W±, and then the Z°, once freed from their symbiotically stabilizing matrix nucleons (troton/beutron), became unstable and began to decay.

Two factors dominated the ensuing events: the relative values of the various binding energies of the involved particles, and their decay rates. The first particle to decay from the rest was the one with the smallest mass, and therefore the lowest binding energy, the W±. It is the outermost component of the weasion. The binding energy of the W±, once released, bathed the contiguous and slightly more massive Z°, causing it to decay in turn. The Z° occupies the next most inward position within the weasion.

Although the matrix W± started to decay before the Z° began its decay, because the latter is slightly more massive, it decayed slightly faster. Therefore, the Z° began to decay before the matrix W™ could complete its decay. During this time overlap, the decay products of both bosons were contemporaneously in situ, abutting the matrix nucleons, even as gravitational compression held them long enough to interact.

The decay channels of the matrix W± (81 GeV and charges +1 and −1=0) should have been three jets of theta-/antitheta+pairs (3 [2 x 13.5 GeV] and charges −1 and +1=0). The decay channels of the Z° (90 GeV and 0 charge) are the W± (81 GeV and charges +1 and −1=0) and should have included a pair of bottom and antibottom quarks (2 x 4.5 GeV and charges +1 and −1=0). Total mass and charge would therefore have been conserved.

However, it must be kept in mind that the W± boson which had been produced by Z° decay had not yet itself decayed, and was still physically intact, at the same place when and where the matrix W± boson had just decayed into the triple pair of theta- (and putative antitheta-) particles, and when and where the bottom (and putative antibottom) quarks first appeared. The W± particle produced by Z° decay was therefore still able to mediate, as a catalyst, both the decays of the putative antibottom quark and that of the three putative antitheta- particles. As a result, all six theta- particles and both bottom quarks were composed of matter only, and four antitauinos balanced the transformations.

Because quarks are stable only as triplets, pairs of bottom quarks are unstable and decay. Catalytic W± boson particles mediated the bottom quark decay (4.5 GeV=3.5 GeV+1.0 GeV), and its decay channels should have been chroton/putative antineutron and/or neutron/putative antichroton mesons, but only matter chrotons and matter neutrons were actually produced, with antineutronic leptons balancing the transformations. Chroton decay produced a seutron, a neutron, and a muino (3.5 GeV=2.5 GeV+1.0 GeV). Seutron decay produced an omega-, a proton, and an antimuino (2.5 GeV=1.5 GeV+1.0 GeV). The ambient energy background determined whether second family particles, or first family particles, or hybridons, or none of them, survived.

Minutes after their fiery passage, the limited lifetime of free roaming neutrons induced their decay, even if they survived the ambient energy background. Any neutrons that were created acted as cocoons that protected putative electrons from certain annihilation during their odyssey through the maelstrom. This is not to suggest that an electron maintains a physical presence inside of a neutron. Rather, it is the energy equivalence of an electron, that is incorporated into the mass of a neutron, which can be considered as potential electron mass, to be converted into physical electron mass, upon the ultimate decay of the neutron. Neutron decay that was mediated by non catalytic weak bosons released the fraternal triplets, a proton, an electron, and an antielectrino. In this very energetic environment, no particle could survive with a rest mass that was not within the energy range of the bottom quark (4.5 GeV-3.5 GeV).

One of the six negatively charged theta- particles attached itself to the positive pole of the catalytic W± boson, creating a theation. Another negatively charged theta- particle attached itself to the positively charged weasion matrix, creating a theasion.

As a proton is to a hydrogen ion (Hp), so a troton is to the ionic equivalent of third family hydrogen, ie. trydrogen (Ht). Trotons and beutrons, having been created at the same point in place and time, interacted the way protons and neutrons interact. Free trotons and beutrons attached themselves to available theta minuses to create the neutral third family atomic analogue of isotopic deuterium, treuterium a/k/a treuteron. Here, the theta- mimics the first family electron, only within the nucleus¹⁰. The combination of a beutron (184.5 GeV) with ionic trydrogen (355.5 GeV), creates treuterium (540 GeV), and with two beutrons, creates ionic third family tritium, trydrogen three (724.5 GeV). The addition of a theta- (13.5 GeV) creates, respectively, atomic trydrogen, atomic treuterium, or atomic trydrogen three. ¹⁰ See also atomic chreuterlum a/k/a chreuteron, composed of a chroton, a seutron and an omega-. The electron/omega minus/theta- relationship to hadron family atomic structure made a serendipitous appearance solely as a consequence of the relative proportions been the hadronic masses set forth above in A PROOF OF THREE FAMILIES BY SIMPLE ADDITION.

Yet, the primary third family hadron is still the troton, and an aggregation of individual trotons, uncombined with less massive beutrons or theta minuses in a compound hadron, remains the densest trotonic material. In other words, compound trotonic isotopes and atoms may be more massive than ionic trydrogen, but they are necessarily less dense.

The characteristics of the relationship between atomic hydrogen and its electron should be similar to that between atomic trydrogen and its theta-, except for the distance of each negative particle from its respective positive nucleon. If this be so, then trotonic atoms (and chrotonic atoms) shed their negatively charged components before, or during, fusion to higher trotonic (and chrotonic) elements. The products of the fission of atomic trydrogen (a troton and a theta- at 355.5 GeV+13.5 GeV=369 GeV), are two beutrons (184.5 GeV+184.5 GeV=369 GeV), where each top quark captures two of the four available bottom quarks¹¹. ¹¹ The neutron-like decay channels of second and third family proton-like hadrons made a serendipitous appearance solely as a consequence of the proportional relationships between the hadronic masses set forth above In A PROOF OF THREE FAMILIES BY SIMPLE ADDITION.

There is a contrasting, but compensating, difference between third family and first family nucleosynthesis. On the one hand, atomic trydrogen, being much more massive than ionic hydrogen, requires more energy, in absolute terms, to initiate fusion. On the other hand, electromagnetically neutral third family atomic nuclei fuse at comparatively lower energies than do positively charged hydrogen ions, because they do not repel one another.

### Cosmic Forge Reprise

Within the expanding sphere of bosions, ionic trydrogen, the densest trotonic material, began to settle out at the epicenter, with less dense, but more massive, trotonic atoms and isotopes forming a central region that was stratified according to nucleon density. Each gaseous trydrogen ion at the epicenter was in touch with the abutting trydrogen ions, and having the same positive charge, resisted fusion. Yet, gravity was sufficiently robust to compress the abutting upper layers of neutral atomic trydrogen/treuterium/trydrogen three nuclei to criticality, whereupon they fused.

The product of the lusion of each atomic trydrogen nucleus (ttb+bbb) is two beutrons (2 tbb), and in the presence of another trydrogen atom (ttb+bbb), creates the third family equivalent of atomic tritium (ttb+2 tbb+bbb), atomic trydrogen three. Its fusion with a troton ion (ttb) transforms atomic trydrogen three into the third family equivalent of singly ionized helium, gaseous trelium (Het4), consisting of two trotons, two beutrons, and a theta- (2 ttb +2 tbb +bbb). The fusion of atomic trydrogen three (2 tbb +ttb +bbb) with a troton atom (ttb +bbb) transforms them into the third family equivalent of atomic helium, trelium (Het4), consisting of two trotons, two beutrons, and two theta minuses (2 ttb+2 tbb+2 bbb). The fusion of two trydrogen atoms (2 [ttb +bbb]) produces atomic trelium, consisting of two trotons and two theta minuses (2 tbb +2 bbb).

The radiation from these fusion transformations bathed and compressed the relatively more dense, but less massive, ionic trydrogen nuclei of the central region, which fused to ionic trelium (Het). Nucleosynthesis had commenced, and the radiation released by trotonic fusion became the mechanism for the transport of excess energy out of the central region. Convection transported the detritus of fusion toward the periphery, while higher mass, less dense, and relatively cooler weasions gravitated inward to replace them.

The intensity of the energy produced at the epicenter was orders of magnitude greater than that produced by first family fusion reactions at the centers of ordinary stars. The more energetic the reaction, the faster it progresses. Consequently, third family fusion proceeded orders of magnitude faster than first family fusion. It follows that nucleosynthesis of more massive third family elements continued in the same manner, ever more quickly after each cycle. Considering the extreme density of the nuclear burning region, other third family elements must have been synthesized up to Fet (trotonic iron, triron), representing a third family extension of the periodic table of the elements.

A major consequence of the first gravitationally driven bosonic decays is that less numerous, but relatively higher mass, first generation bosions in the central region were transformed into more numerous, but relatively lower mass, second generation bosion, third, hybridon, second, and first family particles. Third family hadrons/hybridons could survive at that ambient energy background, but second and first family hadrons decayed in a cascade of progressively less dense and lower mass nucleons, radiation, and neutronic leptons, in a process known as “hadronization”, which is routinely observed in earthbound particle accelerators.

Although some third family hadrons that survived in the central region were relatively more energetic than the outlying bosions, others were relatively less dense and less massive. At this time, gravity was pressing the outlying bosions toward the central region. The resulting mass/density/energy differentials led to the formation of powerful convection currents, which transported the trotonic hadrons outward, to collide with the infalling bosions. Convection replaced radiation as the main mechanism for energy transport outside the central region. The bosion infall zone extended from the central region of active nucleogenesis to the weazonal horizon (Author's choice), which was the expanding boundary where the momentum of the Expansion overcame the gravitational attraction of the center of mass. The diameter of the spherical infall zone can be described as a direct line, drawn between opposite points on the weazonal horizon, and running through the center of mass.

Decay energy generated from hadron/bosion collisions and the gravitational compression of the infalling bosions induced the breaking of bosonic bonds, which generated more energy, that induced further bosion decay, and so on. Through thermal diffusion, the ambient temperature of the energy background became inversely proportional as the square of the distance from the active core. Lower mass bosion, third, second, first family particles and/or hybridons that were produced by bosion decay survived, or decayed, depending upon the mass/energy value of each particle in relation to its physical position within the ambient background energy gradient. Surviving lower mass particles entered the stream of particle flow within the convection currents, either to decay at the higher energy perigees of the descending currents, as they approached the active central region, or to diffuse at the lower energy apogees of the ascending currents, as a plasma of charged particles, into the general bosion population of the Expansion.

The distance between the weazonal horizon and the active central region increased, over time, as the Expansion progressed, but the total mass of matter within the infall zone remained essentially unchanged, even as the density of that matter diminished due to the increase in the weazonal volume. A shifting balance emerged in the compositional ratio of the particles that were in the convection currents of the sphere that was traced out by the circumference of the weazonal horizon. The kinds of rising and falling particles shifted at the contact mixing zone because the available bosions were gradually being transformed into their trotonic decay products. Since the number of available bosions within the infall zone was finite, and their decay at the core interface inexorable, it was inevitable that essentially all of the infalling matter would eventually convert into trotonic particles.

Initially, the convection currents were so strong, and the radiation pressure streaming from the epicenter so intense, that trotonic particles were inhibited from settling to the central region. This had the effect of slowing the amount of mass that was accreting onto the central region, and of permitting a more gradual increase in the ambient temperature at the epicenter, which allowed more time for nucleosynthesis to proceed. A runaway nuclear reaction was thereby avoided.

Analogous to the relationship between iron and the first family table of the elements, triron is probably, but not necessarily, at the stable bottom of a mass/energy well for third family elements. The reason why triron may not be at the bottom is that the rest masses of the neutron and the proton are nearly equal at 1 GeV, whereas the rest mass of the beutron (184.5 GeV) is practically one half that of the troton (355.5 GeV). Therefore, it is likely that the binding energies of trotonic elements permit an extension of the third family periodic table to almost twice that of the first family. In that event, the table may extend far into the third family equivalent of the transuranic elements, and the bottom of the well may be close to truranium.

However, for our purposes, we shall assume that triron is the most energetically stable element in the periodic table of third family elements. Therefore, triron fusion would be prohibited. Consequently, the production of triron would terminate nucleosynthesis within the third family, but in a manner quite different from that of a first family star. The density of first family elements increases from hydrogen to iron. The accumulation of a critical mass of iron nuclei, in the core of a first family star, begins an irreversible contraction because of the gradual dilution of the fuel that is necessary to maintain the pressure of nuclear burning against the crush of gravity. Eventually, gravity overcomes the resistance of the diminished energy produced by nuclear burning elsewhere in the star, and that precipitates its collapse to a neutron or other degenerate star, or to a black hole, depending upon its mass.

Unlike first family elements, trotonic elements decrease in density from trydrogen to triron as they acquire relatively light seutrons, even as they increase in mass. Also unlike first family elements, negatively charged theta minuses are not stripped from their atoms until actual fusion occurs, thereby permitting the negatively charged quark components of the theta- to be present during fusion transformations.

As relatively more dense, but less massive, trydrogen was transformed into relatively more massive, but less dense, trelium, the trelium was convected to the periphery, to be replaced by infalling trydrogen, until the available trydrogen was exhausted. And so it then went, from a trelium core to that of triron, as non-burning triron gradually accumulated into a crust and then a thickening mantle, until it eventually consumed the core. During this process, high energy photons, born in the central nuclear fires, were absorbed and reradiated at lower energies, to escape at the triron periphery. Eventually, the triron replaced the fuel in the nuclear burning region, damping and smothering the nuclear fires.

Nucleosynthesis then ceased, and gravitational collapse quickly transformed the infall zone into the mother of all black holes—the Big Crunch¹². The weazonal horizon was transformed into the black hole horizon. The central region had collapsed to space-time oblivion, leaving only a gravitational ghost. It is there still, and may be found with today's technology. ¹² A term coined by the late David Schramm to describe the concept of the reversal of the cosmic expansion by the ultimate implosion of the Universe. Although that concept is now discredited by evidence of the acceleration of the Expansion, the term has been adopted by the Author for Its powerful Imagery.

### A Central Thought

The Expansion has been compared to spots painted on an inflating balloon, or to a loaf of rising raisin bread, with every raisin in the dough spreading equally away from the others. Well, a balloon and bread each have a center, just like Kansas is to the United States. Yes, Dorothy, there is a Kansas, if you just know where to look. “That's elemental”, she replied.

While it is certainly true that all points in space are receding equally apart from every other point at an increasing velocity directly proportional to the distance between the points Edwin Hubble's redshift law), It is also just as true that the attraction between any two objects in space is proportional to the product of their masses and inversely proportional to the square of the distance between them (Isaac Newton's law of gravitation). Each law is inclusive, not exclusive of the other. This implies that if a singular massive object, created at some time after the Big Bang, were massive enough, it would continue to gravitationally attract every other less massive object that was receding away from it, especially if those less massive objects were created at the same time, and out of the same mass/energy, as that singular large massive object. The latter would assume a central position vis-a-vis all less massive objects, it would become the center of mass between them, if its mass were sufficiently great relative to the total masses of all of the receding objects, and if the mass of each receding object was relatively the same as the other.

It has been observed that groups of galaxies in our local galactic neighborhood are all moving in the same direction toward the constellations Hydra and Centaurus, at a speed of about 500 to 600 kilometers per second. This has been interpreted as the gravitational attraction caused by the concentrated mass of perhaps a million Milky Way galaxies that are located in the direction of movement, between 150 to 350 light years from Earth. That is why it is called the Great Attractor. A similar mass, the Perseus/Pisces supercluster, lies at a similar distance from Earth, but in the exact opposite direction. Both galactic agglomerations appear to be segments in a connecting chain of galaxies known as the Supergalactic Plane.

The Author believes that the Great Attractor is really a great illusion. What is actually being observed are the orbits of local galaxies that are moving in a very shallow arc, around a profoundly more dense central object, lying a great deal further away, but at a 90 degree angle to the direction of movement. Let us call it the Great Centripeter. Those postulated million galaxies are merely the visual effect of parallel lines meeting at a point. If you go down to the local train tracks and observe the rails being squeezed together by the presumed gravitational attraction of a massive object lying just beyond the horizon, you will appreciate the error.

There may be mathematical support, as well as objective evidence, for the proposition that the Expansion is rotating as it moves outward. In 1995, John W. Moffat and Neil J. Cornish published a paper in the Journal of Mathematical Physics which modifies Albert Einstein's theory of general relativity to provide for the twisting and bending of space-time in the presence of a large mass.

In Physical Review Letters, an article by Borge Nodland and John P. Ralston reports their measurements suggesting that the rotational symmetry of space is being violated at cosmic distances. It appears that polarized light from distant galaxies is twisted as a function of its distance from the Earth, and as a function of the direction of the light relative to the angular distance between each such galaxy and the constellation Sextans. The twisting is the most pronounced when the direction to an observed galaxy is most nearly parallel to a line drawn between Earth and Sextans, and the least pronounced when the direction is nearly perpendicular to that line.

Nodland offers, as one of the possible causes of this twisting effect, that space may exhibit a preferred direction. If confirmed, the Author believes that that preferred direction is a fossil manifestation of the physical source which gave rise to the Expansion itself. Because angular momentum is conserved, a preferred direction of space-time indicates that the original source was rotational in nature, and that the radiation background has been rotating perpendicular to the Earth/c>extans axis ever since the radiation first formed.

Even if the speed of the Expansion is appreciably less than the speed of light, every point in space has probably revolved many times around the Great Centripeter since the Big Bang. Therefore, each photon from that ancient and distant era must have taken that much more time to reach our present telescopes than it would have taken in a linear, gravitationally direct, trip. The light we see only appears to be moving in straight lines because space is curved and we are also rotating in the same curved direction. Additionally, as has been confirmed by recent measurements of the ubiquitous background radiation, its photons of light are moving in parallel paths. A helix of curved parallel lines comes to mind as the most probable observational form of the Expansion. In which case, the linear, ie: gravitational, diameter of the Expansion may be a great deal smaller than the observed “red shifts” of distant receding galaxies would make it appear. “red shifts” of distant receding galaxies would make it appear.

An attempt should be made to measure the Expansion since the Big Crunch. Our instruments are now sensitive enough to measure the curvature of the arc section of the Supergalactic Plane visible to us, which is between 300 and 700 light years in length. That will give us the general direction to look, within 180 degrees. Then using the position of the Earth as a central point, and the confluences of the parallel orbit lines on the opposite sides of the Earth as the other two points, it seems rather straightforward that we should be able to triangulate the exact direction to the great circle upon which the Great Centripeter must lie. Perhaps that great circle lies perpendicular to a line drawn between the Earth and Sextans . . . .

The Hubble radius, equal to the time that light could travel since the Big Bang, establishes that the furthest galaxies would be receding from us at the speed of light, a point beyond which is observationally impenetrable. Therefore, the ubiquitous background radiation is a barrier to observational time travel to the Big Bang era. However, the Author contends that radiation did not separate from matter when negatively charged electrons neutralized positive protons in the formation of first family atoms. Rather, that occurred when theta minuses coalesced with trotons, to form neutral third family atoms, which freed the photons to propagate. This event happened after the Big Bang, but before the Big Crunch separated the Great Centripeter from the Weasonal horizon. If this be the fact, then it follows that the elapsed time between the two events translates into some distance between them, and that opens an observational window through which the region surrounding the Great Centripeter might be visible.

Therefore, it may take only the power of our telescopes to resolve this issue. We have already traveled backward in space and time, down the “cone of light”, to the point where the most distant quasars are thinning out. We should soon be entering the “dark zone”, hopefully within the next generation space telescope's furthest “deep field” reach, on the final threshold of a quest for what could prove to be the holey vale of astronomy—the Great Centripeter. Isn't this exciting stuff? If galactic black holes are any guide, we should be looking for an island of light in a sea of nothingness. The Expansion should have drawn away most, if not all, galactic sources of light not gravitationally bound to the Great Centripeter. Therefore, whatever light there is should be emanating from a surrounding halo of galaxies and/or an accretion disc around the Great Centripeter. We have about a ten percent chance that the disc will be relatively more “face on” to us, than “edge on”, in which case it may present an angle of view that would add visible photons to the image. In any event, the disc should be bright in the x-ray spectrum. Of course, whatever the radiation, the spectrum must comprise primordial elements only, with absolutely no trace whatever of any of the heavier elements synthesized in stars, and it will be much further red shifted than any object yet seen, or ever to be seen. That will be its signature. Ye shall know it when ye see it.

As the Oort cloud is vis-a-vis the source of comets around the sun, so must that halo of galaxies be vis-a-vis the Great Centripeter. The total number of galaxies in that halo might even be as numerous as all of the cometary progenitors in the Oort cloud. If so, the number of annual glancing collisions between its individual galactic members must propel a significant portion of them back toward the Great Centripeter. Since the accretion rate of mass onto galactic black holes is as much as one or more solar masses per year, the mass accretion rate onto the Great Centripeter may be on the order of one or more galaxies per year. That kind of illumination kindles the prospect that it may be visible from Earth.

At the June 2000 meeting of the American Astronomical Society, Karl Gebhardt and John Kormendy reported that their measurements of all super massive galactic black holes, then known, revealed that each constitutes approximately 0.2% of the mass of the galactic bulge it inhabits. Although the conditions which give rise to an “ordinary” galactic black hole probably differ from those responsible for the Great Centripeter, if there is a universal relationship between a super massive black hole and the mass of its environment, then the total mass of the Expansion may be extrapolated by calculating the mass of the Great Centripeter.

It is hoped that a concentrated search in the direction of the Great Centripeter will locate its exact position, but just obtaining the distance to the great circle upon which it lies would be valuable. We already know both the speed (500-600 km/sec) and the mass of the Local Group of galaxies which are revolving around the Great Centripeter. Triangulating the linear gravitational distance to it will therefore reveal its mass. Factoring in the estimated number of twisting revolutions taken by the arriving photons since the separation of matter from radiation should determine the approximate duration of the Expansion, less the uncertainty of the time elapsed between the Big Bang and the separation of matter from radiation.

### Beacons from the Edge

Before the Great Centripeter violently separated from the rest of the Expansion, a plasma of electromagnetically positive and negative trotonic ions had diffused among the neutral bosions that were beyond the weazonal horizon. This region encompassed all of the background energy levels below that of the W± bond, and it was populated by gas not dense enough, by itself, for gravity to disturb the bosonic bonds.

Nevertheless, those bonds began to be gravitationally broken by clumps of trotonic ions, that had gradually coalesced around the charged lines of force of the electromagnetic fields within the trotonic plasma that was embedded in the neutral bosion gas. Aggregations of trotonic ions became the initial seeds of mass that were planted in the gravitational fields within the bosion gas. These grew into concentrations large enough to gravitationally fragment portions of the uniformly expanding gas into separate bosion/troton clouds.

As the diverse gasses within each cloud stratified by density, further fragmentation gave rise to the first stellar nurseries. An era of furious stellar formation ensued, which included the spawning of a population of super massive star-like entities, each spanning the diameter of about a light day and containing a billion solar masses, more or less. These were not true stars because nucleogenesis was not the major source of their energy, although the densest gas that settled to their cores did fuse trydrogen to trelium. The bulk mass of these star-like entities consisted of various bosions, largely weasions. As each such stellar object gravitationally contracted, temperature increased with depth, and upon reaching the binding energy level of the weak bosons, the bosions began to decay. As we have observed, the breaking point of bosonic particle bonds must lie between 3.5 GeV and 4.5 GeV.

These stellar objects began to shine with radiation generated by boson decay. In addition to generating energy, the breaking of bosonic bonds released various trotonic particles of diverse density. Because they were released in the upper mantle of each stellar object, where they were surrounded by the ambient background energy of the third family, the relatively dense trotonic particles remained stable. They settled toward the stellar object's epicenter, stratified by density, and they ignited at the ignition point of atomic trydrogen. The less dense detritus of fusion, trelium, was carried toward the stellar periphery by thermal and density driven convection currents that had formed above the now active core, to be replaced by more dense trotonic particles. The ionic trydrogen core, bathed in fusion energy, achieved criticality, and also fused. Radiation generated by core nucleosynthesis was added to the energy mix, and convection within the mantle became the main mechanism to remove excess energy from the core.

Bosions in the upper mantle, at temperatures below that of the binding energy of the W±, served to insulate the core from the temperature/density instabilities at the periphery. The ambient rest mass/energy gradient within the stellar object followed a smooth slope. In the core, third family nucleosynthesis of trydrogen to trelium was maintained by fusion. The smooth decline of gravity as the inverse square of the distance from the core, accompanied by the high-to-low densities and the low-to-high masses of the various trotonic particles in the lower mantle, and of the various bosions in the upper mantle, gradually reduced the rest mass/energy range to the low end of the third family (4.5 GeV-3.5 GeV). At the periphery, the background energy gently curved downward, through the hybridon zone, to the second family energy range (3.5 GeV-1 GeV), and through its hybridon zone, to the first family energy range (1 GeV-0 GeV), at the interstellar medium.

Until this time, second and first family particles, and their hybridons, quickly decayed because, previously, they had all formed above the third family energy range of the bottom quark. Then, when the upward convection currents carried the less dense trotonic particles past the energy range of the bottom quark, at the mantle/periphery transition zone, the trotons were exposed to the decay energies within the range of the second and first families.

Again, the existence of permanent second and first family particles still should have been fleeting, but for a different reason. Now, the renewed presence of non-particle, non-catalytic, weak bosons should have resulted in a cascade of second and first family particles/antiparticles, which would have culminated in the creation of radiation, not matter. Nevertheless, the mantle/periphery transition zone was largely populated by bosions that each incorporated a weak boson particle component. Bosions remain stable from 355.5 GeV to 0 GeV. Actual physical contact between the weak boson component of bosions and the convected trotonic particles resulted in decay products which included second and first family particles of matter only. Antineutronic leptons balanced the transformations.

This was the era when first family matter permanently separated from antimatter. The initial first family particles of stable matter that were dispersed in the solar wind were neutrons that, within minutes, decayed into protons, electrons, and antielectrinos. A hydrogen gas/proton-electron plasma cloud began to surround the stellar object. As the neutron dispersal was continuous, and its decay products permanent, some newly minted neutrons made physical contact and merged with free protons and/or atomic hydrogen before they could decay. Stable neutrons were incorporated into the stellar wind.

Trotonic/chrotonic/protonic particles, that were not in actual physical contact with catalytic bosons, either decayed into matter/antimatter radiation within the mantle/periphery transition zone, or were expelled as a solar wind which again decayed into annihilating radiation. The energy generated from matter/antimatter annihilation broke the weak boson bonds of any adjacent bosions, leading to further trotonic decay, and to the amplification of matter/antimatter energy production. Matter and antimatter annihilate in high energy gamma rays, with an efficiency conversion rate of 100%. Radiation replaced convection as the main mechanism to remove excess energy from the mantle, in the form of a solar wind, at high gamma ray energies.

The most energetic first family nuclear burning star known is called a “pistol star”. It is composed of 1 GeV protons/neutrons and it contains about two hundred solar masses. As we have reasoned, third family hadrons are about the same size as, or marginally smaller than, first family hadrons, but are hundreds of times as massive, eg: atomic trydrogen three is 738 GeV. The same is true of bosions, eg: the theasion is 724.5 GeV. Therefore, a third family/bosion equivalent of a pistol star could easily contain over one hundred thousand solar masses (200×700 GeV=140,000), all within the same approximate volume as a pistol star.

A third family “pistol stellar object” would radiate energy, in quantity and intensity, magnitudes greater than that of a first family pistol star. We call a stellar object that radiates that much power, within such a limited volume of space, from distances close to the beginning of galaxy formation, a quasar. However, such prodigious energy dissipation could not long endure.

### Flash to Darkness

Nucleosynthesis proceeds relatively slowly in sun-like stars because they are relatively not massive, and it may take a hundred billion years for the synthesis of the hydrogen into helium to run its course in the least massive nuclear fusing stars. Iron does not appear in more massive stars until after hundreds of millions to tens of millions of years have elapsed. Because of mass shedding through solar winds, pistol stars, at about two hundred solar masses, represent the extreme limit of mass for any first family nuclear burning star. Such massive stars produce iron in ten million to one million years, and then they explode. However, a quasar is so massive, and nucleosynthesis advances so much faster, that triron is manufactured in hundreds of thousands to tens of thousands of years, or less.

This condemns the typical active quasar to a very short lifetime. The brief life of a quasar implies that the number of quasars actually observed is minuscule compared to the number that have ever existed. This is significant because, if quasars are first family matter factories, then it would require an enormous number of them to account for all of the luminous matter that we see, and much of the dark matter that we infer.

If active quasars do not last long, they probably lack the necessary time to gravitationally augment their bulk from the intergalactic mass reservoir, by merger or otherwise, before their demise. The apparently universal limit to the sizes of quasars of around one light day may be the result of a brief existence of the original, billion mass, bosion/troton cloud fragments.

Accelerated nucleosynthesis may also provide an explanation for the observed brightening of quasars within a single day, or less. This could reflect the effect of core burning that frequently transforms lighter elements to heavier elements, in accelerating step-like increments. The exhaustion of a lighter fuel would lead to the contraction of the epicenter that would create the necessary density and temperature for the ignition of the next more heavy element. Copious production of neutronic leptons would accompany each density collapse. It would then take about a day, traveling at light speed, for those neutronic leptons to reach the bosions at the periphery, there to energize them sufficiently to promote boson decay. Energy released by matter/antimatter annihilation of the bosonic decay products would account for the observed quasar brightening.

A quasar in its death throes collapses catastrophically for the same reasons that led to the Big Crunch, infra., ie: unlike first family elements, trotonic elements decrease in density from trydrogen to triron as they acquire seutrons and/or theta minuses, even as they increase in mass. A quasar composed of trotonic matter would concentrate its most massive, but less dense, particles at the periphery. Non-burning triron would accumulate in a gradually thickening mantle, from the periphery inward to the core, as the active core metamorphosed from trydrogen, through the heavier elements, until the reservoir of the ultimate nuclear fuel, trosilicon, was exhausted. When the last of the trosilicon transformed to triron, there would be no outer shells still burning fuel, as there would be when iron slowly smothers the core of a first family star. Suddenly starved of trotonic fuel, the nuclear fires would be extinguished.

What remains would be a solid ball of triron nuclei. Extreme compression in the core of a first family star does not dissociate the iron nuclei into individual protons and neutrons, because that would recreate the original hydrogen nuclear fuel, which would lead to a continuing recycling of neutrons and protons, and that would violate the prohibition against perpetual motion. As we have reasoned, before that dissociation could occur, the protons in the iron nuclei absorb a quantum of energy from electron decay sufficient to transform themselves into incombustible neutrons.

This is a process of antropic fusion in a subzeta environment (under 90 GeV). In contrast, extreme compression of atomic trotons does result in nucleon dissociation, but into trotonic decay channels. This is a process of antropic fission in a transzeta environment (over 90 GeV). It is probably no coincidence that third family atomic trydrogen, consisting of a troton and a theta- (355.5 GeV+-13.5 GeV=369 GeV) is the mass equivalent of two beutrons (184.5 GeV+184.5 GeV=369 GeV). (See also second family atomic chrohydrogen, consisting of a chroton and an omega- [3.5 GeV+1.5 GeV=5 GeV], which is the mass equivalent of two seutrons [2.5 GeV+2.5 GeV=5 GeV]).

Consequently, a troton within an atomic nucleus, under pressure, will decay into two beutrons, when each top quark captures two bottom quarks that had been donated by theta- decay (175.5 GeV+175.5 GeV+4.5 GeV+3×[4.5 GeV]=184.5 GeV +184.5 GeV). It is theoretically permissible for a less massive quasar to form the degenerate beutron gas analogue of the solid neutron star, because the speed of sound in a gaseous beutron core would not exceed the speed of light. However, the collapse of a sufficiently massive quasar will not be arrested by degenerate beutron pressure, and the ensuing infall would result in the immediate emergence of a black hole.

The collapse of the core through the event horizon of the growing black hole is similar to the draining action of a kitchen sink. Just because the plug is pulled does not mean that the sink empties all at once, or that the water, even under pressure, goes straight towards the hole. Rather, the angular momentum of the spinning core and mantle is conserved, so that the rush to oblivion takes on a circular path.

This means that it takes more time to empty the overlaying mass/energy reservoir than if it had taken a linear path. When you consider that the gravitational drain is narrowing as its downward slope steepens, even as the event horizon widens, then more and more matter is being squeezed into a smaller and smaller escape volume more and more quickly. Particle friction increases with rotational acceleration and compression, which translates into diminished angular momentum and increased resistance, and that results in the need for more time to empty even a gravitational sink.

For every action there is an equal, but opposite, reaction, and the recoiling material imparts an energetic pulse which drives the core through the event horizon. To the extent that the collapse is slowed before the core slides down that gravitational funnel, the resistance of the constricting drain to the infalling material provides a springboard off which a rebounding shockwave expels the remaining bosion/second/hybridon/first family particles of the upper mantle and periphery into the first family interstellar medium. However, during the course of the infall through the event horizon, the outer layers contract with the collapsing sphere at relativistic speed. Depending upon the mass of the sphere at the instant of the collapse, its diameter dramatically shrinks, from a light day to between a light hour and a light second across, before the shockwave rebounds.

Expelled particles immediately decay in matter/antimatter annihilations, at high gamma ray energies. An astronomical object that radiates so much energy, at those frequencies, within such a small volume, at cosmological distances, is called a gamma ray burster.

Matter/antimatter annihilation may resolve an apparent conflict regarding the density of the source of the expelled debris. If the debris were composed of first family matter only, it would block any following gamma rays, which implies that a burster emanates from a low-density source. Yet, the duration of gamma ray bursts indicates that the diameter of the source must be 10 times that of the sun, or less, which implies a high density source. Of course, if the gamma rays emanate from matter/antimatter annihilations within the expanding torus of expelled debris, there is no conflict.

For the first time, on Apr. 25, 1998, a gamma ray burst and a supernova were seen together, in visible light, by Titus J. Galama of the University of Asterdam. Just as notably, the supernova was more energetic in the radio spectrum than any such event to date, as recorded by Mark H. Wieringa of the Australia Telescope National Facility. Could this be the signature of a a dying quasar? This event was located about a hundred times closer than the most distant supernovae, and about one hundred times dimmer than the most energetic supernovae. Since gamma ray bursts are much more energetic than supernovae, and can therefore be seen at much greater distances, perhaps more distant gamma ray bursts are also accompanied by supernovae.

This brings us to the same point that we left after discussing the gravitational collapse of a remnant star, as there appears to be nothing to arrest the ultimate descent to a singularity of all the matter and energy within a black hole. However, appearances can be deceiving.

I claim:

1. A method for generating neutrally charged stable compound particles employing a particle accelerator, comprising the step of:
tuning the particle accelerator to operate at a discrete energy level attendant to the creation of neutrally charged stable compound particles, wherein said compound particles consist of a hadron of the third family of matter and an intermediate vector boson particle, and said compound particles are created at the combined energies which sum to the equivalent rest masses of the interacting particles plus or minus 1 GeV.

2. A method for generating neutrally charged stable particles according to claim 1, comprising the further step of capturing and storing said compound particles to provide an antimatter/particle cascade fuel.

3. A method for generating neutrally charged stable particles according to claim 2, comprising the further step of attaching said compound particles to positive ions for use in particle accelerator applications.
